(19) United States
(12) Patent Application Publication
(10) Pub. No.: US 2026/0289605 A1
(43) Pub. Date: Sep. 24, 2026

(54) SYSTEM

(71) Applicant: SoftBank Group Corp., Tokyo (JP)

(72) Inventor: Miho MIYASHITA, Tokyo (JP)

(73) Assignee: SoftBank Group Corp., Tokyo (JP)

(21) Appl. No.: 19/564,268

(22) Filed: Mar. 12, 2026

(30) Foreign Application Priority Data
Mar. 19, 2025 (JP) 2025-044897

(51) Int. Cl. G06Q 30/0251

(52) U.S. Cl. CPC G06Q 30/0251

(57) ABSTRACT

A system includes a processor that is configured to collect search history and purchase history of an end user and analyze the search history and the purchase history by using natural language processing techniques to estimate interests, preferences, and an emotional state of the end user, input, based on the estimated interests, preferences, and emotional state, a prompt to a generative AI model to instruct the generative AI model to generate personalized text and advertising content, and deliver the generated text and the generated advertising content to the end user via an electronic communication medium.

### CROSS-REFERENCE TO RELATED APPLICATION

This application is based on and claims priority under 35 USC 119 from Japanese Patent Application No. 2025-044897 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional personalization systems that rely on search history and purchase history of end users mainly focus on static or long-term interests and preferences, and often fail to take into account a current emotional state of each end user. As a result, generated messages and advertising content may be perceived as irrelevant, intrusive, or inappropriate in view of how the end user feels at the time of delivery, thereby reducing engagement rates, such as open rates, click-through rates, and conversion rates. Moreover, many existing systems do not effectively utilize advances in natural language processing techniques and generative AI models to dynamically construct high-quality, context-aware text and advertising content that reflects a fine-grained estimation of interests, preferences, and emotional states. Therefore, there is a need for a system that can comprehensively analyze search history and purchase history using natural language processing techniques and machine learning algorithms to estimate not only interests and preferences but also an emotional state of each end user, and that can use such estimation to generate and deliver personalized text and advertising content through a generative AI model in a manner that improves relevance and user satisfaction.

### SUMMARY

In order to solve the above-described problems, the invention provides a system comprising a processor, wherein the processor is configured to collect search history and purchase history of an end user and analyze the search history and the purchase history by using natural language processing techniques to estimate interests, preferences, and an emotional state of the end user. The processor is further configured to input, based on the estimated interests, preferences, and emotional state, a prompt to a generative AI model to instruct the generative AI model to generate personalized text and advertising content, and to deliver the generated text and the generated advertising content to the end user via an electronic communication means. In at least one embodiment, the processor is configured to estimate the interests, the preferences, and the emotional state of the end user in the analysis of the search history and the purchase history by using a machine learning algorithm, thereby improving accuracy and adaptability of the estimation as additional behavioral data are accumulated. In at least one embodiment, the processor is configured to cause the generated text and the generated advertising content to include content personalized based on the interests, the preferences, and the emotional state of the end user, so that the delivered messages and advertising content are dynamically aligned with both long-term preferences and current emotional context, thereby enhancing engagement and effectiveness of communication.

The term “end user” refers to a person who operates a client device or application to access services, content, or products, and who is the subject of the search history and purchase history collected and processed by the system.

The term “search history” refers to a set of records indicating search-related actions performed by an end user, including search queries, associated timestamps, and optionally the content or pages accessed as a result of such searches.

The term “purchase history” refers to a set of records indicating purchase-related actions performed by an end user, including purchased items, transaction times, prices, quantities, and optionally information such as product categories and brands.

The term “natural language processing techniques” refers to computational methods and algorithms for processing and analyzing human language text, including but not limited to tokenization, part-of-speech tagging, sentiment analysis, topic classification, and entity recognition.

The term “interests” refers to domains, topics, product categories, or subject matters that are inferred as being of relevance or attraction to an end user based on the end user's search history and purchase history.

The term “preferences” refers to tendencies or inclinations of an end user toward particular products, services, brands, categories, or attributes, as inferred from the end user's search history and purchase history.

The term “emotional state” refers to an inferred psychological condition or affective status of an end user, such as happiness, sadness, excitement, frustration, or calmness, estimated based on patterns in the search history, purchase history, or related contextual information.

The term “generative AI model” refers to a computational model, such as a neural network-based language model, that is capable of generating text or other content in response to input data, including prompts specifying desired content characteristics.

The term “prompt” refers to input data supplied to the generative AI model, including instructions, constraints, context, or example content, which guide the generative AI model to produce personalized text or advertising content.

The term “personalized text” refers to text generated by the generative AI model that is tailored to a particular end user based on the estimated interests, preferences, and emotional state of the end user.

The term “advertising content” refers to information generated for the purpose of promoting products, services, or brands, including but not limited to promotional messages, product descriptions, offers, or recommendations.

The term “electronic communication means” refers to any communication channel or infrastructure that enables the transmission of data in electronic form, including but not limited to email, in-application messaging, web notifications, and mobile push notifications.

The term “machine learning algorithm” refers to a computational procedure that learns patterns or models from data, such as classification, regression, clustering, or deep learning methods, and that is used to estimate interests, preferences, or emotional states of the end user.

The term “processor” refers to one or more hardware processing units, such as a central processing unit (CPU), a graphics processing unit (GPU), or a dedicated accelerator, which execute instructions to perform the functions described for the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

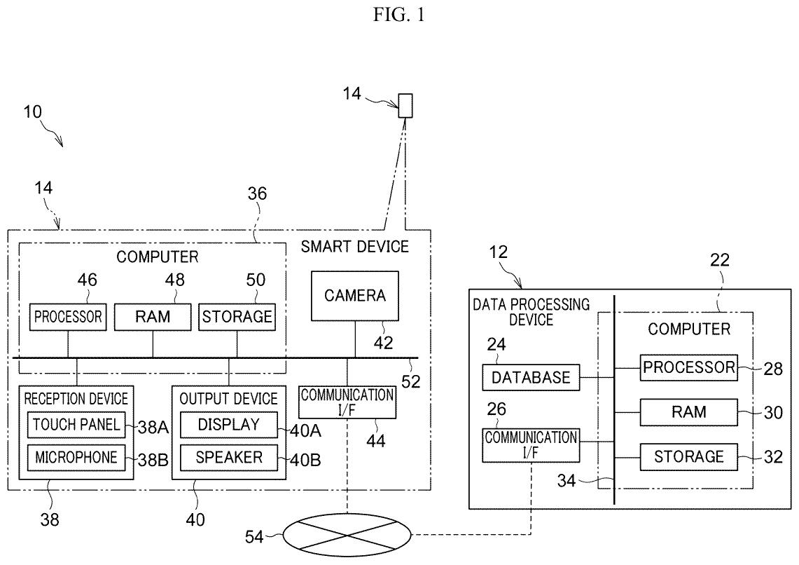

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

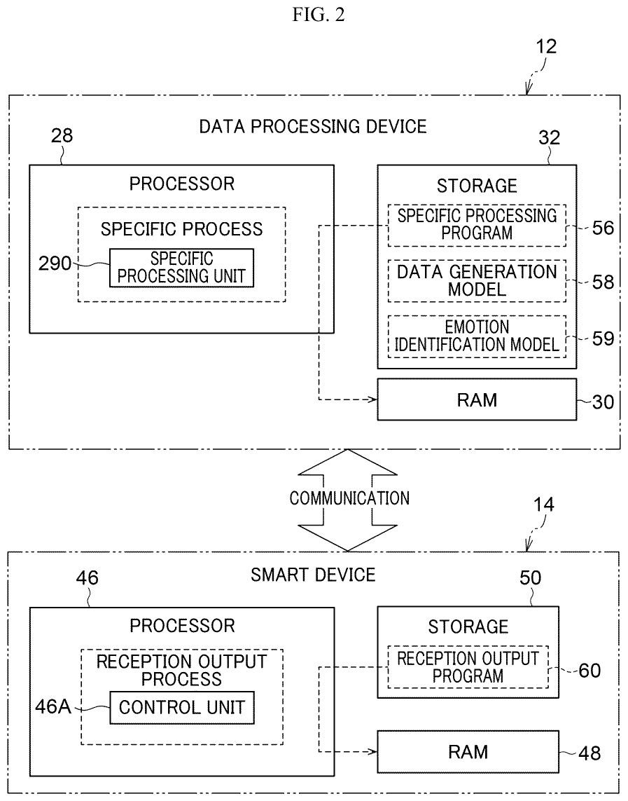

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content personalization systems typically use relatively simple rule-based filtering or coarse-grained profiling of user interests derived from limited signals such as basic browsing history or static demographic attributes. Such systems often treat diverse interaction events uniformly, fail to preserve temporal and contextual structure in user behavior data, and invoke content generation modules with generic instructions that do not fully exploit available user-specific signals. As a result, these systems tend to generate content that is only superficially personalized, lacks appropriate control over structure and detail level, and may include information that is misaligned with the user's current interests or preferences.

From a computer-technology standpoint, there is a need to improve how server-side information processing pipelines (i) ingest and normalize heterogeneous user operation history data, (ii) transform such data into machine-learned representations of user interests and preferences, and (iii) convert these representations into precise, machine-interpretable input for a generative artificial intelligence model. Existing architectures often perform these steps in an ad hoc or loosely coupled manner, leading to inefficient use of computing resources, redundant data processing, and suboptimal control over the generative model's outputs. In particular, they lack a systematic mechanism for constructing structured prompt sentences that encode machine-learned user interest categories, document format constraints, expression style constraints, and information granularity constraints in a way that can reliably steer a generative AI model toward desired output characteristics.
Moreover, many systems do not implement an integrated postprocessing stage that tailors generated content to communication protocols and presentation devices, for example by programmatically adding standardized greeting segments, closing segments, and compliance-related information while preserving the personalized core of the generated content. This absence of an integrated end-to-end pipeline—spanning collection, machine-learning-based analysis, prompt construction, generative model invocation, and protocol-aware postprocessing—limits scalability, consistency of personalization, and effective utilization of modern generative AI capabilities in a networked computing environment. Accordingly, there is a demand for an improved computer-implemented system that: (1) systematically collects and structures fine-grained operation history information, including search character strings, resource identifiers, and time information; (2) applies feature generation and machine learning algorithms to estimate interest and preference categories per end user; and (3) automatically converts these estimated categories and related constraints into structured prompt sentences for a generative AI model, followed by protocol-aware postprocessing and distribution. Such a system should improve the technical functioning of the underlying computing infrastructure by reducing manual configuration, increasing precision and stability of generative outputs, and enabling more efficient, automated end-to-end personalization workflows on server-side computing resources.

The specific processing by the specific processing unit 290 of the data processing device 12 in Example 1 is realized by the following means.

The present invention provides a server comprising a processor configured to collect operation history information of an end user from a terminal via a communication network, to store, as a data set, history information including search character strings, identification information of presentation resources, and time information as the operation history information in association with identification information of the end user, to perform preprocessing on the data set by executing, by use of a data processing program operating on a general-purpose information processing apparatus, data structure conversion, duplicate elimination, and character string normalization, to apply a feature generation algorithm and a machine learning algorithm to the preprocessed data set so as to estimate, for each end user, interest category information and preference category information, and to store the interest category information and the preference category information as interest information in association with the identification information of the end user, the processor being further configured to select, based on the interest information, one or more main interest categories for each end user, to construct a prompt sentence including at least the one or more main interest categories, document format conditions, expression style conditions, and information amount conditions, and to create generation request data including the prompt sentence as input information for a generative information generation model, to execute the generative information generation model on an external information processing service or on an internal information processing resource by using the generation request data, to generate, according to the prompt sentence, personalized text information or advertisement information for each end user, and to acquire the personalized text information or the advertisement information as a generation result, and to perform postprocessing on the acquired personalized text information or advertisement information by adding a greeting sentence, a closing sentence, and compliance information so as to construct personalized distribution content and to transmit the personalized distribution content to the end user via an electrical communication path in accordance with an electronic communication protocol so that a display device of the terminal presents the personalized distribution content. This enables an integrated, computer-implemented pipeline that transforms raw operation history data into structured machine-learned user interest representations, converts those representations into constrained prompt sentences for a generative AI model, and automatically produces and distributes protocol-compliant, personalized content, thereby improving the efficiency, controllability, and technical performance of server-based content personalization and generation.

The term “system” refers to a combination of one or more hardware devices and software components that cooperate to execute the processing described in the claims.
The term “processor” refers to one or more hardware-based processing units, such as a central processing unit or other computation circuitry, configured to execute instructions of a program to perform specified data processing operations.
The term “terminal” refers to an information processing device operated by an end user, including but not limited to a smartphone, tablet, personal computer, or similar user device capable of communication over a network and presentation of content.
The term “end user” refers to a human user who operates the terminal and for whom operation history information is collected and personalized content is generated.
The term “operation history information” refers to data representing interactions performed by the end user via the terminal, including at least search operations, resource viewing operations, and associated temporal context.
The term “search character strings” refers to textual query inputs entered by the end user into a search interface or similar input field on the terminal for the purpose of retrieving information resources.
The term “identification information of presentation resources” refers to data that uniquely or semi-uniquely identifies information resources accessed or displayed on the terminal, such as uniform resource locators, resource identifiers, or similar referencing information.
The term “time information” refers to temporal data indicating when a particular operation event in the operation history information occurred, including at least timestamps or time ranges.
The term “data set” refers to a structured collection of operation history information records that are stored in association with identification information of an end user and are used as input for subsequent data processing.
The term “identification information of the end user” refers to data that distinguishes one end user from another, such as a user ID, account identifier, or other unique or pseudo-unique identifier.
The term “general-purpose information processing apparatus” refers to a computing platform not limited to a specific dedicated function, such as a server computer, virtual machine, or cloud computing resource capable of executing arbitrary software programs.
The term “data processing program” refers to software instructions executable by the processor to carry out operations including data structure conversion, duplicate elimination, character string normalization, feature generation, machine learning processing, and related steps.
The term “data structure conversion” refers to processing that transforms operation history information from one representation format into another representation format suitable for analysis, such as converting raw logs into tabular or vectorized structures.
The term “duplicate elimination” refers to processing that detects and removes redundant or repeated operation history records so that substantially identical entries do not appear multiple times in the data set used for analysis.
The term “character string normalization” refers to processing that standardizes text data, including, for example, converting characters to a unified case, removing or replacing punctuation, unifying encoding formats, or handling whitespace in a consistent manner.
The term “feature generation algorithm” refers to a computational procedure that transforms raw input data, including textual information, into numerical or categorical features that can be consumed by a machine learning algorithm.
The term “machine learning algorithm” refers to a computational model or method that infers patterns or relationships from data, including, for example, classification models, clustering models, or other predictive or descriptive models.
The term “interest category information” refers to data representing one or more thematic or topical categories inferred for an end user based on operation history information, indicating subjects likely to be of interest to the end user.
The term “preference category information” refers to data representing one or more preference-related categories inferred for an end user, such as favored content types, styles, or product categories, derived from operation history information.
The term “interest information” refers to information that includes at least the interest category information and the preference category information associated with the identification information of the end user.
The term “main interest categories” refers to one or more interest categories selected from among the interest category information as being relatively more relevant or dominant for a particular end user.
The term “prompt sentence” refers to text data that is provided as input to a generative artificial intelligence model and that encodes, in natural or structured language, conditions including main interest categories, document format conditions, expression style conditions, and information amount conditions.
The term “document format conditions” refers to constraints or specifications included in the prompt sentence indicating a desired structural format of generated content, such as an email body, newsletter, or report, and may include layout or sectioning requirements.
The term “expression style conditions” refers to constraints or specifications included in the prompt sentence indicating a desired linguistic style of generated content, such as friendliness level, formality, tone, or narrative style.
The term “information amount conditions” refers to constraints or specifications included in the prompt sentence that define a desired volume or granularity of information in the generated content, such as a character count range, word count range, or summary depth.
The term “generation request data” refers to structured data transmitted to a generative information generation model and including at least the prompt sentence and, optionally, model parameters or control settings.
The term “generative information generation model” refers to an artificial intelligence model configured to generate text or other information based on input data including a prompt sentence, and may include, for example, a generative language model.
The term “external information processing service” refers to a remotely provided computing service accessible via a communication network and capable of executing the generative information generation model, such as a cloud-based inference service.
The term “internal information processing resource” refers to a computing resource under control of the system operator, such as an on-premises server or private cloud resource, configured to execute the generative information generation model.
The term “personalized text information” refers to generated textual content whose topics, style, and structure are adapted to characteristics of a particular end user based at least on the interest information.
The term “advertisement information” refers to generated content intended for promotional or marketing purposes, including advertising messages and commercial information tailored to interest information of the end user.
The term “generation result” refers to output produced by the generative information generation model in response to the generation request data, including at least personalized text information or advertisement information.
The term “postprocessing” refers to processing performed after acquisition of the generation result, including adding or modifying text segments such as greeting sentences, closing sentences, and compliance-related information, and formatting content for distribution.
The term “greeting sentence” refers to a text segment included at or near the beginning of the personalized distribution content that addresses the end user in a standardized or semi-standardized manner.
The term “closing sentence” refers to a text segment included at or near the end of the personalized distribution content that provides a closing expression, such as a sign-off or call to action.
The term “compliance information” refers to text or metadata included in the personalized distribution content to satisfy legal, regulatory, or policy requirements, such as disclosures, consent-related statements, or unsubscribe information.
The term “personalized distribution content” refers to a complete content entity prepared for transmission to an end user, including at least the personalized text information or advertisement information and postprocessed segments such as greeting, closing, and compliance information.
The term “electrical communication path” refers to a communication channel implemented using electrical or electromagnetic signals conveyed through a communication network, such as the Internet or other data networks.
The term “electronic communication protocol” refers to a set of rules and formats used to transmit data over the electrical communication path, including, for example, email protocols, web protocols, or messaging protocols.
The term “display device of the terminal” refers to a visual output apparatus included in or connected to the terminal, such as a liquid crystal display, organic light-emitting diode display, or other screen configured to present the personalized distribution content.

In one embodiment, a server implements the claimed system by executing a set of software modules on one or more hardware platforms such as a rack-mounted general-purpose computer, a virtual machine instance in a cloud computing environment, or a cluster of such machines. The server includes at least one central processing unit, a main memory, a non-volatile storage device, and a network interface controller. The server executes an operating system such as a general-purpose server operating system, a web server program such as a common HTTP server, an application framework such as a typical web application framework, a database management system such as a relational database server, and various data processing libraries including a numerical computation library, a data frame processing library, and a machine learning library.

The server executes an application program that implements modules including a data collection module, a history storage module, a preprocessing module, a feature generation module, a machine learning inference module, a prompt construction module, a generative AI invocation module, a postprocessing module, and a delivery module. These modules may be implemented as separate processes, as components within a single process, or as microservices communicating via remote procedure calls or message queues.
The terminal operates as an end-user device, such as a smartphone, tablet, or personal computer, and executes a browser application or a dedicated application that communicates with the server over a packet-switched network using secure transport protocols. The terminal records user interactions, for example search queries entered into a search field, resource identifiers of content pages that the user opens, and timestamps corresponding to these interactions. The terminal packages such operation history information in a structured representation and transmits the information to the server via an application programming interface endpoint provided by the server.
The server receives operation history information from the terminal and stores it as structured records in a database. The server associates each record with identification information of the end user. The server stores, for each end user, search character strings, identification information of presentation resources such as resource locators, and time information including timestamps or time ranges. By storing the records in normalized tables, the server enables efficient indexed search, aggregation, and retrieval operations. The server uses a schema in which each history record is associated with a user identifier, an event type, a content identifier, and a timestamp, which permits efficient range queries and aggregation by user.
The server executes the preprocessing module on the stored data in the database. The server uses a data frame processing library running on the processor to load batched subsets of the history records into memory. The server converts raw log-like structures into table-like structures with explicit typed fields. The server performs data structure conversion to unify various event formats, for example, mapping different logging sources into a consistent schema. The server performs duplicate elimination by comparing key attributes such as user identifier, event type, content identifier, and timestamp to identify and remove redundant records. The server performs character string normalization by converting characters to a standard form, applying case folding, unifying Unicode normalization forms, and optionally stripping diacritics and punctuation. The server may also normalize resource identifiers by removing tracking parameters and mapping equivalent resource variants to a canonical form.
The server applies a feature generation module that transforms normalized textual data into numerical feature vectors. The server uses a feature extraction algorithm such as term frequency-inverse document frequency vectorization, subword or character n-gram encoding, or learned embedding projection. For example, the server may apply a bag-of-words or n-gram model with dimensionality reduction techniques such as singular value decomposition to generate dense feature vectors representing search character strings and resource content titles. The server may also incorporate temporal features, such as recency weights, into the feature vectors by decaying older events or by appending features that encode time bins.
The server executes a machine learning inference module implemented using a machine learning library. In one embodiment, the server uses a classifier or clustering algorithm, such as a k-means clustering model, a logistic regression classifier, a gradient boosting model, or a feedforward neural network, to map feature vectors to interest category information and preference category information. In another embodiment, the server uses a deep learning model, for example a multi-layer neural network with rectified linear unit activations, batch normalization, and dropout regularization, to compute probability distributions over a predetermined set of interest categories. The server trains such models offline using labeled training data derived from historical user behavior and optional manual annotations. During training, the server partitions the data into training and validation sets, uses an optimization method such as stochastic gradient descent or an adaptive gradient method, and minimizes a loss function such as cross-entropy or mean squared error. The server updates model weights based on the gradient of the loss function with respect to the weights, thereby improving prediction accuracy over successive epochs.
The server, during inference, loads trained model parameters from persistent storage into memory and applies them to the feature vectors derived from current operation history information. The server computes, for each end user, interest category information representing topics such as “latest smartphones,” “technology news,” or “mobile photography,” and preference category information representing, for example, preferred content types (such as long-form articles, concise summaries, or promotional offers) and stylistic preferences (such as formal tone or casual tone). The server stores these interest and preference category values as interest information in a separate database table, keyed by user identifier, enabling later retrieval and updating.
The server constructs one or more main interest categories for each end user by selecting categories whose predicted scores exceed a threshold or by selecting the top-ranked categories. This selection may involve applying non-trivial rules that balance diversity and focus, for example choosing one primary category and one secondary category when their scores are within a specified ratio. By formalizing these selection rules in code rather than manual heuristics, the server ensures consistent behavior at scale, which is difficult to achieve with human manual processes.
The server then constructs a prompt sentence to be supplied to a generative AI model. The server uses the main interest categories, document format conditions, expression style conditions, and information amount conditions stored in configuration tables or derived from user preferences. The server assembles these elements into a natural language instruction that encodes explicit constraints controlling the generative model's output. For example, the server may construct the following prompt sentence:
“Generate an English email body that provides up-to-date information about the latest smartphones and recent technology news. The target user frequently searches for ‘latest smartphone’, ‘tech news’, and ‘smartphone camera review’. The tone should be friendly but concise, and the length should be around 300 words.”

In another case, the server may construct the following prompt sentence: “Create a personalized newsletter text in Japanese summarizing this week's most important technology news and the newest flagship smartphones. Assume the reader is highly interested in mobile photography and camera performance. The style should be suitable for an email newsletter and the main body should be less than 250 words.”

The server encapsulates the constructed prompt sentence in generation request data that also includes model selection parameters, temperature controls, maximum token limits, and other decoding parameters. The server selects an appropriate generative AI model, in one embodiment a transformer-based language model with multiple layers of self-attention and feedforward networks. The server may use an external information processing service that hosts such a model behind a network API, or may execute an equivalent generative model on an internal information processing resource using an inference runtime optimized for matrix operations on central processing units or accelerator hardware.
The server communicates with the generative AI model via a strictly defined application programming interface. The server transmits the generation request data over a secure channel and receives a response that contains one or more candidate generated texts. The server parses the response, selects the best candidate based on criteria such as likelihood scores, length conformity, and presence or absence of undesirable tokens, and designates the selected generated text as personalized text information or advertisement information for the corresponding end user.

The server performs postprocessing on the generated content. The server adds a greeting sentence, a closing sentence, and compliance information, which may be stored in a template repository and parameterized by user attributes and legal jurisdiction. The server concatenates these segments with the generated core body while preserving markup appropriate for the chosen communication protocol, such as simple text or structured markup language for email. The server may also adapt content to the capabilities of the terminal, for example by limiting line length for small screens or by stripping unsupported formatting tags.

The server transmits the personalized distribution content to the terminal using an electronic communication protocol, such as an email transport protocol, a push notification protocol, or a web messaging protocol. The server uses an outbound mail transfer agent or an external messaging service to deliver the content to the recipient address associated with the user identifier. The terminal receives the message through its client application, decodes the protocol-specific envelope and body, and renders the personalized distribution content on the display device. The user views the personalized text and may interact with any included links, which can in turn generate new operation history information sent back to the server, thereby closing a feedback loop.
The server, by structuring user operation history as normalized records with explicit schema fields, improves data management and enables efficient querying and aggregation using database indexes. This reduces computational load and memory footprint during preprocessing because the server can select only relevant subsets of data for specific users or time windows. The server, by applying automated feature generation and machine learning algorithms, achieves finer-grained and more stable classification of interest and preference categories than manual or rule-based systems. This classification reduces noise in the signals passed to the generative AI model, which in turn reduces the amount of trial-and-error and manual prompt tuning required to obtain suitable outputs.
The server, by constructing prompt sentences that encode machine-learned user interest categories and explicit structural, stylistic, and information volume constraints, improves controllability of generative model behavior. The prompt sentences do not merely replicate what a human operator would type; instead, the server automatically derives them from numerical category scores using non-traditional mapping rules that adjust content type and depth based on user interest distributions. This mapping includes, for example, scaling the requested level of detail with the predicted strength of user interest, or adjusting tone according to inferred preference categories. These automated constructions lead to a more efficient use of computational resources by reducing the need for repeated generative calls and manual curation.
The server, by integrating preprocessing, machine learning inference, prompt construction, model invocation, and postprocessing into a unified pipeline, reduces latency and network overhead. The server can schedule batched processing of multiple users'history records, reuse feature extraction and model inference results, and parallelize generative calls while enforcing rate limits. This improves throughput and reduces the time between a user action and the delivery of updated personalized content. Additionally, by generating content that is more closely aligned with user interests and device context, the system reduces unnecessary data transmission of irrelevant or unwanted content, thereby contributing to lower communication load.
In one alternative embodiment, the server uses a neural network-based interest classifier implemented as a multi-layer perceptron or a recurrent or transformer-based encoder that processes sequences of user events. The server represents each event as a concatenation of an embedding of the search character string, an embedding of the resource identifier, and an encoding of time information. The server trains this model to predict topic distributions over a fixed vocabulary of interest categories. The server uses a cross-entropy loss function and applies regularization techniques such as dropout to prevent overfitting. The server periodically retrains the model using newly accumulated operation history data to adapt to evolving user behavior patterns. By using such sequence-aware models, the server captures order and context effects that are difficult to account for in simple rule-based systems, thereby further improving interest inference accuracy and reducing misclassification errors.
In another embodiment, the server deploys multiple generative AI models of different sizes or capabilities and selects among them based on the complexity of the constructed prompt sentence and the resource constraints. For example, for short, low-detail prompts, the server may select a smaller model running on internal hardware, while for complex prompts requiring nuanced language and style control, the server may select a larger model hosted on an external service. The server maintains statistics about the performance and cost of each model variant and applies a decision policy to balance quality and resource utilization. This architecture allows the server to optimize technical performance, such as throughput and latency, while still maintaining high personalization accuracy.
The server improves computer technology by providing specific internal data structures, algorithms, and processing sequences that enhance the efficiency and quality of generative content personalization. The server does not merely automate human decision making; instead, the server leverages machine-learned representations, structured prompt sentences, and a coordinated multi-module pipeline that humans could not practically execute at scale or with the same consistency. The result is a reduction in computational redundancy, improved data locality in memory and storage, more accurate and stable generative outputs, and reduced communication overhead, all of which are realized through concrete improvements in the manner in which the server and terminal cooperate to process, generate, and present information.

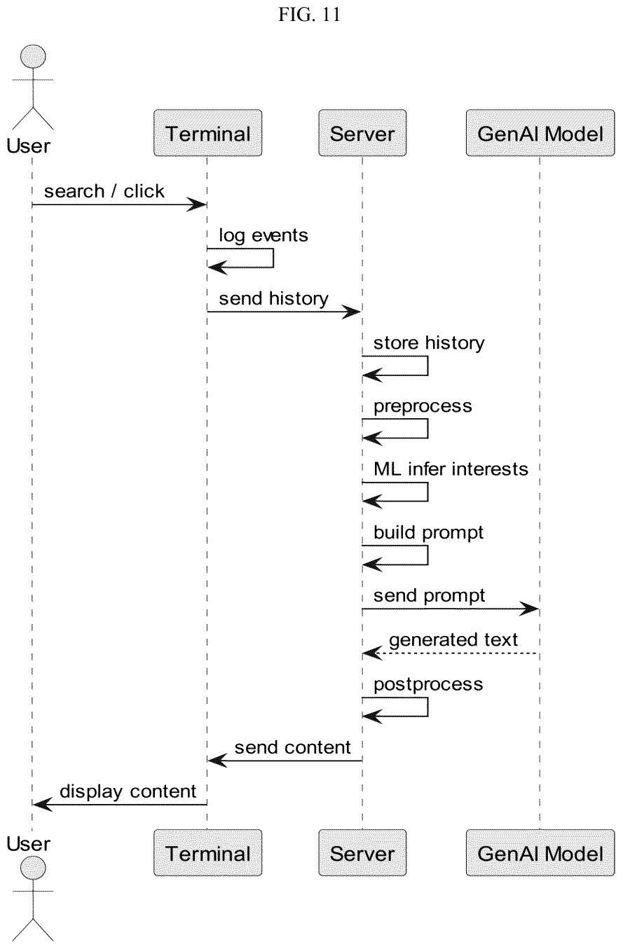

The following describes the processing flow using FIG. 11.

### Step 1:

The user operates the terminal and generates operation history information.
The user inputs search character strings into a search box, clicks hyperlinks, scrolls pages, and opens or closes content items. The terminal records, as input, these user actions together with associated data such as queried text, resource identifiers, and timestamps.
The terminal structures this input as operation history entries, each entry including at least a user identifier, an event type (for example, search or page view), a resource identifier (for example, a URL), and a timestamp. The terminal outputs a locally buffered sequence of structured operation history entries ready for transmission to the server.

### Step 2:

The terminal transmits the operation history information to the server.
The terminal takes, as input, the buffered operation history entries created in Step 1 and an authentication token associated with the user. The terminal serializes these entries into a request payload and sends the payload to the server over a secure communication protocol via an application programming interface endpoint. During this transmission, the terminal performs data encoding and attaches header information including the authentication token and user identifier. The terminal outputs a network request carrying the structured operation history information as its payload.

### Step 3:

The server receives and stores the operation history information.
The server receives, as input, the network request generated by the terminal in Step 2. The server parses the request, validates the authentication token, and extracts the operation history entries. The server performs data validation to ensure required fields such as user identifier, event type, resource identifier, and timestamp are present and correctly formatted. The server then writes each validated entry into one or more database tables, such as a user table and a history table, using transaction-controlled insert operations. The server outputs persistent database records in which each operation history entry is associated with a user identifier and stored in a normalized schema.

### Step 4:

The server selects operation history records for analysis.
The server takes, as input, the persistent history records stored in the database and a selection condition, such as a specific user identifier and a time window (for example, the past 30 days). The server executes a database query to retrieve only those records matching the selection condition. During this data retrieval, the server uses indexed columns for user identifier and timestamp to reduce access time and disk operations. The server outputs a result set of history records for one or more users, structured as a table-like list of entries.

### Step 5:

The server performs preprocessing on the selected history data.
The server receives, as input, the result set of history records from Step 4. The server loads these records into an in-memory data structure such as a table representation. The server performs data structure conversion by transforming differently formatted event records into a uniform schema, for example mapping various event types to a consistent set of fields. The server then detects and removes duplicate entries by comparing key fields, eliminating redundant records that share the same user identifier, event type, resource identifier, and timestamp. The server normalizes character strings, converting text to a consistent case, applying Unicode normalization, and removing or replacing special characters to reduce variability. The server outputs a cleaned and normalized data table in which each row corresponds to a unique, standardized history event suitable for numerical processing.

### Step 6:

The server generates feature vectors from the preprocessed data.
The server takes, as input, the cleaned and normalized history table from Step 5. The server aggregates events per user by grouping rows based on user identifier and concatenating or otherwise combining related text fields such as search character strings and resource titles. The server then applies a feature generation algorithm, for example a term frequency-inverse document frequency transformation or another vectorization method, to convert aggregated text for each user into numerical feature vectors. The server may append additional features representing temporal aspects, such as recency weights or time-of-day usage patterns. The server outputs, for each user, a numerical feature vector or a set of vectors that encode the user's historical behavior in a form suitable for machine learning processing.

### Step 7:

The server infers interest and preference categories using a machine learning model.
The server receives, as input, the feature vectors output in Step 6 and a trained machine learning model loaded into memory. The server processes each feature vector through the model, which may be a classifier, clustering algorithm, or neural network. As the model processes each vector, the server performs matrix multiplications, applies activation functions, and computes output scores corresponding to potential interest and preference categories. The server interprets these scores as probabilities or similarity measures and determines which categories apply to each user by applying decision criteria such as thresholding or top-k selection. The server outputs, for each user, interest category information and preference category information, each represented as one or more category labels with associated scores.

### Step 8:

The server selects main interest categories for each user.
The server takes, as input, the interest category information and preference category information produced in Step 7. The server ranks categories according to their scores and applies selection rules to choose one or more main interest categories per user. For example, the server may select the top-ranking category and any additional categories whose scores exceed a fraction of the top score. The server may also enforce diversity constraints, such as not selecting categories that are too similar to each other. The server outputs, for each user, a reduced list of main interest categories that represent the most salient topics for personalization.

### Step 9:

The server constructs a prompt sentence for the generative AI model.
The server receives, as input, the main interest categories from Step 8, as well as configuration data describing document format conditions, expression style conditions, and information amount conditions. The server converts the main interest categories into human-readable topic phrases and combines them with format, style, and length constraints. The server then assembles these elements into a coherent natural language instruction that explicitly encodes what type of content is requested, how it should be structured, what tone it should have, and how long it should be. For example, the server may output the following prompt sentence for a specific user:
“Generate an English email body that provides up-to-date information about the latest smartphones and recent technology news. The target user frequently searches for ‘latest smartphone’, ‘tech news’, and ‘smartphone camera review’. The tone should be friendly but concise, and the length should be around 300 words.”
As another example, the server may output the following prompt sentence:
“Create a personalized newsletter text in Japanese summarizing this week's most important technology news and the newest flagship smartphones. Assume the reader is highly interested in mobile photography and camera performance. The style should be suitable for an email newsletter and the main body should be less than 250 words.”
The server outputs a constructed prompt sentence and associated control parameters for use by the generative AI model.

### Step 10:

The server creates generation request data and invokes the generative AI model.
The server takes, as input, the prompt sentence and control parameters from Step 9. The server packages them into generation request data that includes model identification, decoding parameters such as temperature and maximum number of tokens, and any additional options. The server sends this generation request data to a generative AI model executed either on an external service or on an internal computation resource through a programmatic interface. The generative AI model processes the prompt sentence and returns one or more generated text candidates. The server receives and parses the response, extracting the generated text content and evaluating it based on criteria such as length conformity and absence of disallowed patterns. The server outputs selected personalized text information or advertisement information tailored for each user.

### Step 11:

The server postprocesses the generated content.
The server receives, as input, the personalized text information or advertisement information produced in Step 10, along with template data for greeting sentences, closing sentences, and compliance information. The server inserts a greeting sentence at the beginning of the generated content, appends a closing sentence at the end, and adds required compliance information, such as legal notices or unsubscribe instructions, at designated positions. The server may also adjust formatting to match protocol requirements, for example by converting line breaks, inserting markup tags, or encoding characters. The server outputs a finalized piece of personalized distribution content that combines the generative core with standardized framing and compliance elements.

### Step 12:

The server delivers the personalized distribution content to the terminal.
The server takes, as input, the personalized distribution content from Step 11 and the contact information associated with the user, such as an email address or messaging identifier. The server composes a protocol-specific message that includes headers, subject line, and body content, and then submits this message to a delivery subsystem such as an email transfer agent or a push notification gateway. The server transmits the message over an electronic communication path according to the selected communication protocol. The server outputs a delivered message that is stored in the user's mailbox or message queue and is available for retrieval by the terminal.

### Step 13:

The terminal receives and displays the personalized distribution content.
The terminal receives, as input, the delivered message sent in Step 12 when the terminal's client application connects to the relevant communication server. The terminal downloads the message, decodes its headers and body, and reconstructs the personalized distribution content. The terminal renders the content on its display device, applying local styling rules and adapting to screen size and orientation. The user views the displayed personalized content and may interact with embedded links or controls. The terminal outputs updated user interaction events, which become new operation history information that can be transmitted to the server, thereby initiating a new iteration of the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content personalization systems typically rely on simple rule-based filters or coarse-grained user segmentation. In many cases, such systems merely match a current page view or a small set of recent queries to preauthored messages, without deeply analyzing longer-term behavioral history. As a result, the generated content is often generic, repetitive, and poorly aligned with a user's nuanced interests, preferences, and emotional state. This leads to low engagement rates, reduced effectiveness of electronic advertising, and inefficient utilization of network and compute resources because large volumes of non-relevant content are transmitted and processed.

Furthermore, known systems that employ machine learning for recommendation generally focus on predicting a next item or click, and do not provide a structured mechanism to convert behavioral history into machine-interpretable topic information and then into optimized prompt sentences for a generative AI model. In such architectures, a generative AI model may receive manually crafted or static prompts that are insensitive to the user's current context or affective state, causing suboptimal text generation and requiring significant manual tuning by human operators. This results in increased development effort, inconsistent quality of generated content, and underutilization of the capabilities of the generative AI model.

In addition, conventional server-side pipelines for user-behavior analysis and content generation often consist of loosely coupled components that do not systematically integrate natural language processing, behavioral statistics, and machine learning-based state estimation into a unified prompt-construction process. The absence of a coordinated pipeline generates technical inefficiencies: redundant data transformations, latency due to unnecessary network calls, and resource overhead caused by repeatedly executing the generative AI model with poorly specified inputs. These inefficiencies degrade system-level performance, including throughput, response time, and computing resource utilization.

Accordingly, there is a need for an improved computer-implemented system that (i) systematically transforms raw behavioral history information, including search history and purchase history, into structured topic information, (ii) estimates a user's interest, preference, and emotional state using natural language processing and machine learning techniques, and (iii) automatically constructs optimized prompt sentences for a generative AI model such that the model can efficiently generate personalized text information and advertising information. There is also a need to reduce manual configuration effort, improve the relevance and quality of generated content, and enhance overall performance and scalability of the server-side processing pipeline in an electronic communication environment.

The specific processing by the specific processing unit 290 of the data processing device 12 in Application Example 1 is realized by the following means.

The present invention provides a server comprising a processor and a memory storing instructions that, when executed by the processor, cause the processor to acquire, via an input/output interface and an electronic communication network, user behavioral history information including search history information and purchase history information from a user terminal, store the behavioral history information as structured information in a storage device, aggregate the stored behavioral history information by using a general-purpose information processing program and a data processing program, generate topic information representing matters of interest related to the user by performing extraction of phrases, normalization of word forms, and calculation of occurrence frequencies with a natural language processing program, estimate an interest, a preference, and an emotional state of the user based on the topic information and statistical information of the behavioral history information by using a machine learning algorithm, automatically generate a prompt sentence, which is an instruction sentence to be input to a generative AI model, in accordance with the estimated interest, preference, emotional state, and the topic information by selecting at least one text template information item associated with the topic information and inserting the topic information and sales promotion condition information into variable portions of the selected text template information item, input the prompt sentence to the generative AI model to cause the generative AI model to generate personalized text information and advertising information for the user, construct, by using a telecommunication service program, an electronic message including the text information and the advertising information as an electronic mail, and transmit the electronic mail to the user terminal via an electronic communication unit. This enables an integrated and technically efficient server-side pipeline that converts raw behavioral history into optimized prompt sentences for a generative AI model, thereby improving the relevance and personalization of generated content, reducing manual configuration, and enhancing overall system performance in terms of processing efficiency, resource utilization, and responsiveness in an electronic communication environment.

The term “user behavioral history information” refers to electronic data representing actions performed by a user, including but not limited to search history information, purchase history information, and browsing-related events, which are collected from a user terminal over a communication network.

The term “search history information” refers to electronic records indicating search operations performed by a user, including search queries, associated timestamps, and optionally related resource identifiers such as accessed uniform resource locators.

The term “purchase history information” refers to electronic records indicating transactions or acquisition activities performed by a user, including purchased items or services, transaction times, quantities, and prices.

The term “user terminal” refers to an electronic device operated by a user, such as a mobile device, a tablet device, a desktop terminal, or a similar computing device, that is capable of communicating with a server over a communication network.

The term “information processing apparatus” refers to an electronic computing arrangement including at least one processor, a memory, and an input/output interface, configured to execute programs for processing data.

The term “input/output apparatus” refers to a hardware or software interface component that enables data to be exchanged between the information processing apparatus and external devices or networks, including but not limited to network interface controllers and communication middleware.

The term “electronic communication path” refers to a logical or physical communication route established over a communication network for transmitting and receiving electronic data between devices.

The term “storage device” refers to a hardware component or a combination of hardware components, such as a magnetic storage unit, a solid-state storage unit, or a network-based storage unit, configured to store electronic data persistently or semi-persistently.

The term “structured information” refers to data represented in an organized format such as records, tables, or data objects, in which fields and relationships are explicitly defined to facilitate data processing.

The term “general-purpose information processing program” refers to software instructions executed by a processor for performing general data manipulation and control operations, including but not limited to program flow control, data retrieval, and data transformation.

The term “data processing program” refers to software instructions executed by a processor for performing specific data aggregation, filtering, computation, or transformation operations on stored data.

The term “natural language processing program” refers to software instructions and associated models executed by a processor for analyzing and processing natural language text, including operations such as tokenization, part-of-speech tagging, syntactic parsing, phrase extraction, and word form normalization.

The term “topic information” refers to electronic data representing one or more abstracted subjects, themes, or categories that are inferred from user behavioral history information and that characterize matters of interest related to a user.

The term “phrases” refers to sequences of one or more words extracted from text, which function as linguistic units and may indicate entities, concepts, or actions.

The term “normalization of word forms” refers to a text processing operation that converts words into standardized forms, such as converting inflected or derived forms into base or lemma forms, in order to unify similar expressions.

The term “calculation of occurrence frequencies” refers to a data processing operation that counts how often particular phrases, tokens, or terms appear within a data set, and records such counts as frequency information.

The term “interest” refers to an inferred tendency of a user to pay attention to or seek information about particular topics or categories.

The term “preference” refers to an inferred inclination of a user to favor certain items, categories, or attributes over others, based on patterns in the user behavioral history information.

The term “emotional state” refers to an inferred affective condition of a user, such as a positive, neutral, or negative sentiment, derived from analysis of behavioral history information or related context.

The term “statistical information of the behavioral history information” refers to numerical or categorical summaries derived from user behavioral history information, including but not limited to counts, frequencies, distributions, and co-occurrence measures.

The term “machine learning algorithm” refers to a computational method that utilizes training data to build a model capable of performing tasks such as classification, regression, or clustering, and that can estimate or predict user-related states from input features.

The term “classification” refers to a machine learning process in which input data are assigned to one or more predefined categories based on learned patterns.

The term “regression estimation” refers to a machine learning process in which one or more continuous or ordered output values are estimated from input features based on a learned functional relationship.

The term “generative AI model” refers to a generative information processing model implemented by software and/or hardware, configured to receive input data such as a prompt sentence and to output generated content including text information and advertising information.

The term “prompt sentence” refers to an instruction sentence or set of sentences prepared as input for the generative AI model, the content and structure of which guide the generative AI model in generating desired output content.

The term “text information” refers to machine-generated or machine-processed textual content in natural language form, which may include explanatory text, descriptive text, or other narrative content.

The term “advertising information” refers to text information or mixed-media information intended to promote, recommend, or publicize goods, services, or events to a user.

The term “text template information item” refers to electronic data defining a reusable text pattern including fixed portions and variable portions, wherein the variable portions are configured to be replaced with specific information such as topic information or promotion conditions.

The term “sales promotion condition information” refers to data specifying conditions or parameters of a sales promotion, such as discounts, campaign periods, target products, eligibility criteria, or call-to-action details.

The term “telecommunication service program” refers to software instructions executed by a processor for constructing, formatting, and transmitting electronic messages over a communication network, including but not limited to email transmission programs.

The term “electronic message” refers to a structured digital communication unit, including header information and body content, that is transmitted between devices via a communication network.

The term “electronic mail” refers to a type of electronic message conforming to a standard message format, which can be delivered to and stored in a user's mailbox of an electronic mail system.

The term “electronic communication unit” refers to a hardware and/or software component that implements transmission and reception of electronic data over a communication network according to one or more communication protocols.

In one embodiment, a server implements the claimed system as a network-connected information processing apparatus. The server includes at least one multi-core central processing unit, a main memory, a non-volatile storage device, and a network interface. The server executes an operating system such as a UNIX-like operating system and runs application programs written in a general-purpose programming language such as a high-level scripting language. The server also accesses an external or internal storage system such as a relational database management system.

A terminal operates as a user-side device. The terminal is, for example, a smartphone, a tablet, or a personal computer equipped with a processor, a memory, a display, user input devices, and a wireless or wired communication interface. The terminal executes a client application or a web browser. The terminal acquires user behavioral history information, including search history information and purchase history information, and transmits this information to the server via a communication network using an application-layer protocol such as HTTP over TLS.

A user operates the terminal to perform search operations, page browsing, and purchase transactions. The terminal records search history information including search queries and timestamps, and purchase history information including item identifiers, transaction times, and prices. The terminal periodically or event-driven transmits the behavioral history information to the server as structured messages, for example as messages encoded in a text-based structured format. The terminal may also maintain a local cache of recent behavioral events and synchronize the cache with the server in accordance with network conditions, thereby reducing redundant transmissions and lowering communication load.

The server stores the received behavioral history information in the storage device as structured information. The server uses a relational database schema in which a user table, a query table, and a transaction table are defined. The server maps each received behavioral event to a record in the appropriate table. The server assigns primary keys and foreign keys to relate queries and transactions to individual users. The server thus maintains behavioral history information as normalized structured information rather than as unstructured log files. This structured storage improves data retrieval efficiency, reduces storage redundancy, and enables more effective indexing and query optimization.

The server executes a data processing program to aggregate behavioral history information. The server loads behavioral records from the database into an in-memory data structure such as a tabular data frame. The server groups behavioral records by user identifier, filters records by a time window, and computes counts and frequencies of search queries and purchased item categories. The server thereby computes statistical information of the behavioral history information. Because the server performs aggregation in memory using a columnar data structure, the data processing program can leverage vectorized operations, which improve processing throughput compared to row-wise manual processing.

The server executes a natural language processing program to analyze textual elements of the behavioral history information. The server applies tokenization to split search queries and item descriptions into tokens. The server performs part-of-speech tagging and syntactic parsing using a statistical or neural natural language model. The server extracts noun phrases and named entities as candidate phrases representing topics or product categories. The server performs normalization of word forms by converting inflected words to base lemmas and by applying lowercasing and character normalization. The server also removes stop words according to a predefined stop word list. The server then calculates occurrence frequencies of normalized phrases per user. This specific combination of phrase extraction, normalization, and frequency calculation transforms raw text into structured topic information that can be efficiently processed by subsequent machine learning algorithms.

In one embodiment, the server applies a machine learning algorithm to estimate an interest, a preference, and an emotional state of the user based on the topic information and the statistical information of the behavioral history information. The server represents each user by a feature vector. The feature vector includes, for example, normalized frequencies of top phrases, distribution of purchased categories, recency-weighted counts of certain actions, and sentiment scores computed from text associated with user actions. The server may compute sentiment scores using a sentiment analysis model that maps words and phrases to sentiment values and aggregates them.

The server inputs the feature vectors into a trained machine learning model. In one embodiment, the server uses a neural network classifier or regressor with an input layer corresponding to the feature vector dimensions, one or more hidden layers employing non-linear activation functions, and an output layer representing interest categories, preference intensities, and emotional state values. The server trains the neural network using supervised learning. During training, the server minimizes a loss function such as a cross-entropy loss for categorical outputs and a mean squared error loss for continuous outputs. The server updates the weights of the neural network using a gradient-based optimization algorithm. The server may use mini-batches of training data and an adaptive learning rate schedule to improve convergence speed and stability. By using such a structured feature representation and a trained neural architecture, the server can infer user states with higher accuracy and robustness than rule-based systems.

In another embodiment, the server employs an ensemble model combining a gradient-boosted decision tree model for interest and preference classification with a neural network model for emotional state regression. The server combines outputs from these models to form a consolidated user state representation. This combination can provide improved performance in heterogeneous data scenarios by exploiting the strengths of both tree-based and neural-based algorithms.

The server automatically generates a prompt sentence for a generative AI model using the topic information and the estimated user states. The server maintains a set of text template information items. Each text template information item includes fixed portions and variable portions. Fixed portions define generic structures for marketing or informational messaging, while variable portions are placeholders for topic information, sales promotion condition information, and descriptors of user interest, preference, or emotional state. The server selects at least one text template information item associated with the topic information and the user states. The server selects the template by evaluating template metadata and matching topic categories and intensity levels of interest or preference.

The server fills the variable portions of the selected text template information item with specific values. For example, the server inserts a topic such as “running” or “home coffee equipment” into a topic placeholder, and inserts a limited-time discount description and a campaign period into a sales promotion placeholder. The server may also adjust tone descriptors in the prompt sentence based on the estimated emotional state, such as specifying a more encouraging tone when the user is inferred to be a beginner. The server thus generates a prompt sentence that is structurally and semantically tailored to the individual user and to the generative AI model.

For example, when the server determines that the user has strong interest in running and marathon topics, the server generates a prompt sentence such as: “Generate ad copy with the latest promotions for running-related products that users have recently shown interest in. Imagine you're targeting beginner marathoners who prioritize lightweight and cushioned shoes.”

In another case, when the server identifies an interest in home coffee equipment, the server generates a prompt sentence such as: “The user has recently searched for home coffee maker, espresso beans, and coffee grinder. Write an engaging promotional email introducing premium home coffee equipment and a special bundle offer. Highlight flavor, convenience, and a limited-time discount code.”

These prompt sentences are not manually crafted for each user but are generated dynamically based on structured topic and state representations and template selection logic. This structured prompt generation improves consistency and machine-readability of the prompts and allows the generative AI model to receive richer, more precise instructions compared to ad-hoc human-authored prompts.

The server interacts with a generative AI model implemented as a large-scale neural network. The generative AI model includes multiple layers, such as an embedding layer for token representations, multiple self-attention layers for contextual encoding, and a final decoding layer that outputs probability distributions over vocabulary tokens. The server inputs the prompt sentence to the generative AI model as a sequence of tokens. The generative AI model generates text by iteratively predicting the next token according to the learned probability distribution, conditioned on the prompt sentence and previously generated tokens.

The server configures parameters of the generative AI model call, such as a maximum output length and a temperature parameter controlling randomness. The server may adjust these parameters based on the desired style or length of the advertising information. Because the prompt sentence contains explicit topic information, promotion conditions, and tone guidance, the generative AI model can generate text information and advertising information that requires fewer decoding steps and fewer re-generation attempts compared to generic prompts. This leads to reduced compute time and improved throughput when running on shared computing resources.

The server receives the generated text information and advertising information from the generative AI model and post-processes it. The server may perform additional natural language checks, such as ensuring that required promotion conditions are mentioned and that certain prohibited terms are not included. The server may also truncate or lightly reformat the generated text to fit email layout constraints. Because the generative AI model output is already constrained by the prompt sentence structure, the amount of post-processing is relatively small, which contributes to reduced server-side processing time.

The server constructs an electronic message including the generated text information and advertising information. The server uses a telecommunication service program to build an electronic mail with standard headers, including a sender address, a recipient address corresponding to the user, a subject line, and a body containing the generated content. The server may embed tracking links pointing to a content delivery system. The server then transmits the electronic mail to the user terminal via an electronic communication unit over a communication network. The server may use a mail transfer protocol and may manage a queue of outgoing messages to optimize network utilization and prevent congestion.

The terminal receives the electronic mail via an email client application. The user views the generated advertising information on the display of the terminal. If the user selects a link in the advertising information, the terminal opens a resource such as a web page. The terminal may log this interaction and send additional behavioral history information back to the server, thereby creating a feedback loop. The server can incorporate this feedback into subsequent behavioral history aggregations and machine learning estimations, improving the accuracy and responsiveness of user modeling over time.

This architecture produces technical effects beyond mere automation of human tasks. Because the server transforms raw behavioral logs into structured topic information and uses a learned mapping from features to user states, the server reduces noise and redundancy before invoking the generative AI model. This reduces the amount of data processed by the generative AI model and lowers computational overhead. The use of structured prompt sentences derived from templates and learned user states also reduces the number of model invocations required to obtain suitable content, which improves latency and throughput. The database schema and in-memory data structures are chosen to minimize I/O overhead and to exploit vectorized operations, thereby improving processing speed for large-scale user populations.

Moreover, the machine learning and natural language processing components implement non-conventional processing sequences. The server does not simply pass raw queries or pages to a model; instead, the server performs specific intermediate transformations including feature extraction, topic mapping, sentiment scoring, and template-based prompt construction. These intermediate structures allow the server to implement caching strategies, such as caching topic information per user and only recomputing it when new behavioral history surpasses a threshold. This further reduces repeated computations and improves computational efficiency.

The neural network used for user state estimation differs from conventional recommender systems in that it outputs not only item rankings but structured psychological descriptors such as interest levels and emotional state values. This enables the server to adjust prompt construction and generative model parameters in a more fine-grained manner. For example, when the emotional state estimation indicates a low-engagement state, the server may select templates that produce shorter messages with stronger call-to-action elements, which reduces data transfer size and can improve user response probability. This explicit coupling between state estimation outputs and prompt design constitutes a technical improvement in how generative models are controlled and integrated into a communication system.

In additional embodiments, the server may employ alternative model architectures, such as convolutional neural networks for short text classification, recurrent neural networks for temporal modeling of user sessions, or autoencoder-based models for dimensionality reduction of high-dimensional behavioral features. The server may also vary the training method, for example by using semi-supervised learning or transfer learning from pre-trained language models for the user state estimation task. The server may use different loss functions, such as focal loss for imbalanced classes or Huber loss for robust regression. These variations allow the system to be adapted to different data distributions and performance requirements while retaining the same overall data flow and technical benefits.

In another embodiment, the server deploys multiple generative AI models specialized for different domains, such as sports, electronics, or household goods. The server selects which generative AI model to use based on the topic information and may adjust the prompt sentence accordingly. By routing requests to domain-specialized generative AI models, the server can improve content relevance and reduce model size per domain, which leads to better memory utilization and faster inference times on the underlying hardware.

In yet another embodiment, the server employs compression and quantization techniques for both the user state estimation model and the generative AI model. The server uses reduced-precision representations for model weights and activations during inference, which decreases memory bandwidth requirements and reduces power consumption while maintaining acceptable accuracy. This embodiment is particularly advantageous when the server operates in an environment with constrained computational resources.

By combining structured storage of behavioral history, explicit feature engineering and topic extraction, machine learning-based user state estimation, template-based prompt sentence generation, domain-aware selection of generative AI models, and efficient electronic message construction and transmission, the server implements a specific and improved computer-centric pipeline. This pipeline enhances processing speed, accuracy of personalization, and resource efficiency compared to conventional systems that either rely on manual prompt design or directly feed unstructured logs into a generative model. The described embodiments thus provide concrete technical improvements in the operation of the server and the communication system as a whole, rather than merely automating a pre-existing human process.

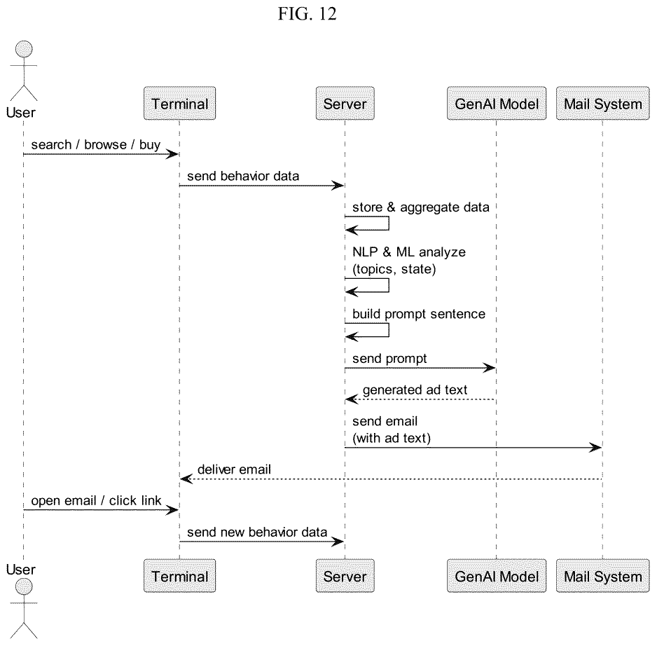

The following describes the processing flow using FIG. 12.

### Step 1:

The terminal records user behaviors and transmits behavioral history information to the server.
The input to this step is user actions, such as the user entering search queries, viewing pages, and performing purchase operations on the terminal. The terminal monitors these actions and converts them into behavioral records. The terminal stores, for each action, data items including a user identifier, a query string or item identifier, a timestamp, and optional metadata such as a page URL or category label. The terminal then packages multiple behavioral records into a message and transmits the message to the server via a communication network using a secure protocol. The output of this step is a structured behavioral history message delivered from the terminal to the server.

### Step 2:

The server receives the behavioral history message and stores the behavioral history information as structured information in a storage device.
The input to this step is the behavioral history message transmitted by the terminal. The server parses the message, validates required fields such as user identifiers and timestamps, and maps each behavioral record to a corresponding schema in a relational database. The server writes records into tables representing users, search events, and purchase events, assigning primary keys and foreign keys to maintain relationships. The server may also index frequently used columns such as user identifiers and timestamps.
The output of this step is a set of normalized database records representing user behavioral history information stored persistently in the storage device.

### Step 3:

The server aggregates the stored behavioral history information and computes statistical information for each user.
The input to this step is a collection of behavioral records retrieved from the storage device. The server loads these records into an in-memory tabular data structure and groups them by user identifier. The server filters records by a specified time window and counts occurrences of search queries, item categories, and other behavioral features. The server calculates statistics such as frequency distributions of query terms, purchase counts per category, and recency-weighted action counts. The output of this step is a per-user statistical profile that summarizes behavioral patterns in a compact numerical form.

### Step 4:

The server applies a natural language processing program to extract phrases and normalize word forms from textual elements in the behavioral history information.
The input to this step is textual data such as search queries and item descriptions associated with each user, together with the corresponding statistical profile. The server tokenizes the text into words, performs part-of-speech tagging, and identifies noun phrases and named entities as candidate topics. The server normalizes word forms by converting inflected forms to lemmas and applying case normalization and character normalization.
The server calculates occurrence frequencies of the normalized phrases for each user and removes low-frequency or stop-word phrases. The output of this step is a list of normalized phrases with associated frequencies for each user, which forms raw topic information.

### Step 5:

The server generates topic information representing matters of interest related to each user based on the extracted and normalized phrases.
   The input to this step is the list of normalized phrases and their frequencies for each user. The server groups related phrases using predefined mappings or clustering logic, for example mapping phrases such as “running shoe,” “marathon training,” and “sportswear” into a single topic “running.” The server may apply thresholds on frequency and recency to select significant topics. The server thus converts many individual phrases into a smaller set of topic labels that characterize user interests. The output of this step is topic information, represented as a set of topic labels and associated scores for each user.

### Step 6:

The server estimates an interest, a preference, and an emotional state of each user using a machine learning algorithm based on the topic information and the statistical information.
The input to this step is the topic information and the per-user statistical profile generated in the previous steps. The server constructs a feature vector for each user, combining topic scores, behavior counts, temporal features, and optional sentiment scores derived from text. The server feeds these feature vectors into a trained machine learning model, such as a neural network or an ensemble of decision trees. The model processes the feature vectors to produce output values, for example probabilities over interest categories, continuous scores representing preference strength, and sentiment or emotional scores. The output of this step is an estimated user state comprising interest categories, preference intensities, and emotional state values for each user.

### Step 7:

The server selects a text template information item and automatically generates a prompt sentence for a generative AI model using the topic information and the estimated user state.
The input to this step is the topic information and the estimated interest, preference, and emotional state for each user, together with a library of text template information items. The server evaluates metadata associated with each template, such as applicable domains, message length, and tone, and selects at least one template that matches the user's dominant topics and state. The server fills variable portions of the selected template with specific values, including the main topic, related topics, sales promotion condition information such as discount details and campaign periods, and descriptors of the target user (for example, “beginner runner”). The server thus assembles a coherent instruction string for the generative AI model. The output of this step is a prompt sentence tailored to the particular user and use case.

### Step 8:

The server provides the generated prompt sentence to the generative AI model and causes the generative AI model to generate personalized text information and advertising information.
The input to this step is the prompt sentence produced in Step 7. The server encodes the prompt sentence as a sequence of tokens and sends these tokens to the generative AI model, which is implemented as a neural network with multiple layers. The generative AI model computes internal representations and predicts output tokens sequentially to form a coherent text response. The server receives the generated output tokens from the model and decodes them into natural language text. The generated text includes descriptive information and promotional content aligned with the topics and promotion conditions contained in the prompt sentence. The output of this step is personalized text information and advertising information specialized for the corresponding user.

### Step 9:

The server post-processes the generated text information and constructs an electronic mail message containing the advertising information.
The input to this step is the generated text information and advertising information from the generative AI model, along with user contact information stored in the database. The server checks the generated text against constraints, such as inclusion of mandatory promotion terms and exclusion of prohibited expressions, and trims or reformats the text if necessary. The server then creates an electronic mail message by setting a sender address, a recipient address corresponding to the user, a subject line derived from the main topic, and a body that includes the generated advertising information and links to relevant resources. The output of this step is a complete electronic mail message ready for transmission.

### Step 10:

The server transmits the electronic mail message to the terminal via an electronic communication unit.
The input to this step is the constructed electronic mail message from Step 9. The server uses a telecommunication service program and an electronic communication unit to send the message over a communication network using a mail transfer protocol. The server may enqueue the message, apply rate limiting, and record transmission status. The message travels through mail delivery infrastructure and is eventually delivered to the user's mailbox associated with the terminal. The output of this step is successful delivery of the personalized electronic mail to the terminal.

### Step 11:

The terminal receives the electronic mail and presents the personalized advertising information to the user.
The input to this step is the electronic mail delivered by the server. The terminal's email client retrieves the message and stores it in local or remote mail storage. The terminal displays the subject line and body content on the screen when the user opens the message. The advertising information appears with text and links as generated in prior steps. The output of this step is the visual and interactive presentation of the personalized advertising information to the user on the terminal.

### Step 12:

The user interacts with the personalized advertising information and optionally triggers additional behavioral history events.

The input to this step is the advertising information displayed on the terminal. The user reads the content and may click or tap on embedded links, view landing pages, or initiate purchases. The terminal logs these interactions as new behavioral events, including link-click events and subsequent browsing or purchase actions. The terminal may then send these new events to the server as additional behavioral history information. The output of this step is updated behavioral history information that reflects the user's response to the personalized advertising, which can be used as new input to Step 1 in subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional personalization systems in network-based information services often rely on manually designed rules, coarse-grained segmentation, or superficial analysis of user behavior logs. In many cases, a server merely counts page views or aggregates simple statistics over search and purchase histories, and delivers pre-defined or template-based content that is only loosely related to an end user's real interests. As a result, the delivered content frequently fails to reflect nuanced differences in user preference or context, leading to reduced user engagement and inefficient utilization of network and computing resources.

Furthermore, when conventional systems attempt to incorporate machine learning, they typically separate the steps of user modeling and content generation in an ad hoc manner. For example, a conventional server might infer a user's interest category using a statistical model, but then pass only a coarse label to a generic content generator, such that the generated content is not tightly conditioned on the user's detailed behavior history or current context. In particular, known systems do not systematically exploit text-based feature extraction from behavior histories in combination with dynamically generated prompt sentences tailored to a generative AI model. Consequently, conventional generative models are under-utilized, and the content they produce may be generic, redundant, or mismatched with the user's current interest.

Additionally, existing architectures often treat log collection, data preprocessing, user preference estimation, prompt construction, and content delivery as loosely coupled modules, which leads to latency, inconsistency of user models, and difficulty in scaling. The absence of an integrated pipeline—from behavior data acquisition through text-based statistical learning, to prompt generation and personalized content delivery—limits the ability of the system to adapt in near real time to changes in user behavior. This constraint degrades the technical performance of the system, including processing efficiency on the server, relevance of generated content, and throughput of personalized message delivery over the communication network.

Accordingly, there is a need for a computer-implemented technique that improves the operation of a server by: (i) systematically acquiring and structuring behavior history data from communication terminals, (ii) transforming such data into text feature quantities suitable for statistical learning, (iii) inferring user attribute information that represents fine-grained concern fields and preference tendencies, and (iv) dynamically generating prompt sentences and target information for a generative AI model so that personalized information content can be generated and distributed efficiently and accurately. By improving these technical components, the overall computer system can deliver more relevant content with lower manual configuration, better resource utilization, and improved responsiveness to user behavior, thereby constituting a concrete improvement in computer and network technology.

The specific processing by the specific processing unit 290 of the data processing device 12 in Example 2 is realized by the following means.

The present invention provides a server comprising a processor and a storage device, the processor being configured to acquire, from a communication terminal, behavior history data regarding an end user's information search actions and information browsing actions, preprocess the behavior history data as text information, convert the text information into text feature quantities using a language processing algorithm, estimate user attribute information indicating a concern field and a preference tendency of the end user by performing statistical learning processing based on the text feature quantities, store the user attribute information in the storage device, extract target information having high relevance to the user attribute information from an information storage device, dynamically generate a prompt sentence to be input to a generative AI model on the basis of the user attribute information and the target information, input the prompt sentence and the target information into the generative AI model to cause the generative AI model to generate personalized information content for the end user, and configure the personalized information content as an information message to be transmitted to the end user via an electronic communication medium and distribute the information message to the communication terminal of the end user through a communication network. This enables a technical improvement of the server-side information processing pipeline by tightly integrating behavior data acquisition, text-based statistical learning of user attributes, dynamic prompt sentence construction, and generative AI-based content generation, thereby allowing the computer system to automatically produce and deliver highly relevant personalized information messages with improved processing efficiency, reduced manual rule design, and enhanced responsiveness to changes in the end user's behavior.

The term “behavior history data” refers to data representing actions performed by an end user in connection with information search and information browsing, including at least search terms input by the end user and identification information of information presentation screens accessed by the end user.

The term “communication terminal” refers to an electronic device operated by an end user and configured to communicate with a server over a communication network, such as a personal computer, a smart phone, a tablet device, or any other network-capable user device.

The term “end user” refers to a human user who operates a communication terminal to access information or services provided by a server over a communication network.

The term “information search actions” refers to operations performed by an end user to retrieve information via a network-based service, including but not limited to inputting search terms into a search field and issuing search requests to a server.

The term “information browsing actions” refers to operations performed by an end user to view information provided by a server, including accessing web pages, opening product detail screens, scrolling through lists of items, or otherwise displaying information on a communication terminal.

The term “search terms” refers to character strings or textual expressions input by an end user into a search interface of a network-based service for the purpose of retrieving relevant information.

The term “identification information of information presentation screens” refers to data that uniquely or distinguishably identifies an information presentation screen, such as a uniform resource locator, a screen identifier, a page path, or other screen-level identification data.

The term “text information” refers to data represented as a sequence of characters or tokens, including but not limited to search terms, titles, descriptions, or other textual elements derived from behavior history data.

The term “text feature quantities” refers to numerical or symbolic feature representations derived from text information, generated by applying language processing algorithms such as tokenization, normalization, vectorization, or embedding, and used as input to statistical learning processing.

The term “language processing algorithm” refers to a computational procedure for processing text information, including at least one of tokenization, segmentation, normalization, stop-word removal, stemming, lemmatization, or other natural language processing techniques.

The term “statistical learning processing” refers to computer-implemented processing that applies a statistical or machine learning model to input feature quantities in order to infer patterns or output variables, including but not limited to clustering, classification, or regression.

The term “statistical learning model” refers to a computational model that processes feature quantities to perform tasks such as clustering, classification, or prediction, including unsupervised learning models and supervised learning models.

The term “user attribute information” refers to information indicating characteristics of an end user inferred from behavior history data, including at least a concern field and a preference tendency, and optionally one or more scores or categories representing degrees of interest.

The term “concern field” refers to a category or domain of content, goods, or services in which an end user is estimated to have an interest, such as a product category, a service category, or a topic category.

The term “preference tendency” refers to a direction, strength, or pattern of an end user's interest within one or more concern fields, expressed for example as preferences for certain item types, attributes, or subcategories.

The term “storage device” refers to a hardware or virtual component configured to store data, including but not limited to a non-volatile memory, a magnetic storage device, a solid-state drive, or a database system implemented thereon.

The term “information storage device” refers to a storage device or storage system that stores content or item-related data, including product information, service information, or other target information usable for content generation.

The term “target information” refers to information selected based on user attribute information, including data related to content items, goods, or services that have high relevance to an end user's inferred concern field and preference tendency.

The term “prompt sentence” refers to a natural language or structured text input formulated for a generative AI model, the prompt sentence specifying at least conditions, constraints, or context to be used by the generative AI model when generating output content.

The term “generative AI model” refers to a trained information processing model that generates new content, such as text, based on input data including a prompt sentence and optional contextual information, and that uses machine learning techniques such as deep learning.

The term “personalized information content” refers to content generated for a specific end user by a generative AI model on the basis of user attribute information and target information, the content being tailored in at least its subject matter, details, or expression style to that end user.

The term “information message” refers to a data structure or communication unit configured for transmission to a communication terminal via an electronic communication medium, including at least a subject field, a body field, and optionally one or more links or metadata fields.

The term “electronic communication medium” refers to a mechanism for transmitting digital information over a communication network, including at least electronic mail, messaging services, or other network-based communication protocols.

The term “communication network” refers to a wired or wireless network infrastructure used to transmit data between a server and a communication terminal, including at least public networks, private networks, or combinations thereof.

The term “server” refers to an information processing apparatus or a group of apparatuses including at least one processor and at least one storage device, configured to provide information processing services and communication functions to one or more communication terminals.

In one embodiment, a server cooperates with a terminal and a user to implement a system for generating and delivering personalized information content by using behavior history data, statistical learning, and a generative AI model controlled by a dynamically constructed prompt sentence. The server physically comprises at least one processor, a main memory, a non-volatile storage device, and a network interface, and executes software modules that implement data acquisition, text preprocessing, feature extraction, user-attribute estimation, prompt construction, generative content creation, and message delivery. The terminal comprises a display unit, an input unit, and a communication interface, and executes a browser or dedicated application. The user operates the terminal. The server is implemented, for example, as a rack-mounted computing device including a multi-core central processing unit such as a general-purpose processor with vector instruction support, a main memory such as a dynamic random access memory, and a non-volatile storage device such as a solid-state drive on which an operating system, an application server, and a database system are installed. The server executes application software implemented, for example, using a general-purpose programming language runtime, a web framework, a statistical computing environment, and a machine learning library such as a numerical computation library and a machine learning toolkit. The server connects to a network through a network interface controller supporting packet-based communication such as Transmission Control Protocol and Internet Protocol.

The terminal is implemented, for example, as a mobile computing device or a personal computer and executes a web browser. The terminal sends hypertext transfer protocol requests to the server and executes script code embedded in web pages to generate behavior history data. The user issues search queries, selects links, and views information by operating input components of the terminal such as a keyboard, a pointing device, or a touch panel.

The server uses a logging module to receive behavior history data from the terminal. The server stores this behavior history data in a database as records. Each record includes at least a user identifier, a timestamp, a search term string, and screen identification information such as a URL or page identifier corresponding to an information presentation screen browsed by the user. The server uses a relational database system to store the behavior history data in structured tables. For example, the server stores behavior history data in a table with columns such as user_id, event_type, term_text, screen_id, and event_time. By structuring the data in this manner, the server can efficiently perform indexed queries and join operations, thereby reducing the latency of subsequent analysis steps.

The server uses a preprocessing module implemented in a statistical computing environment to process the behavior history data as text information. The server retrieves sets of behavior records for each user and concatenates relevant textual fields such as search terms and screen titles into text sequences. The server then applies a language processing algorithm such as tokenization, normalization, stop-word removal, and stemming to these sequences. For example, the server converts all characters to lowercase, removes punctuation, splits text at word boundaries, removes high-frequency function words such as “the” or “and,” and optionally applies stemming or lemmatization to reduce inflected forms to base forms. The server uses a feature extraction library such as a term frequency-inverse document frequency vectorizer to convert the processed tokens into text feature quantities represented as numerical vectors. These vectors are sparse high-dimensional vectors where each dimension corresponds to a token, and each value corresponds to a weight expressing the importance of the token within a user's behavior history. By converting behavior history data into normalized feature vectors in this manner, the server improves the comparability of users, reduces noise, and enables efficient matrix operations that are optimized by numerical libraries and processor vector instructions.

The server uses a learning module to estimate user attribute information from the text feature quantities. In one embodiment, the server uses a clustering model such as k-means clustering to group users based on their feature vectors. The server initializes cluster centers, iteratively assigns user vectors to the nearest center according to a distance measure such as cosine distance, and updates cluster centers by computing mean vectors. The server repeats this procedure until a convergence criterion is met. The server then labels each cluster with a concern field such as “sports goods,” “consumer electronics,” or “home appliances” by examining the tokens with the highest weights in the cluster center vectors. The server also computes preference tendency scores, such as probability-like values indicating the strength of association between a user and one or more concern fields. The server stores this user attribute information in a user attribute table, for example with columns such as user_id, primary_field, secondary_field, and a serialized structure representing scores.

In another embodiment, the server uses a supervised classification model such as a neural network classifier to estimate user attribute information. The server prepares training data consisting of text feature quantities derived from behavior histories and ground-truth labels representing concern fields. The server uses a neural network architecture including an input layer of size equal to the number of features, one or more hidden layers with nonlinear activation functions such as rectified linear units, and an output layer with a softmax activation to output probabilities over concern fields. The server defines a loss function such as categorical cross-entropy, and uses an optimization algorithm such as stochastic gradient descent or an adaptive optimization method to update weight parameters. During training, the server repeatedly performs forward propagation to compute output probabilities, computes the loss, and performs backpropagation to compute gradients and update the weights. The server may use regularization techniques such as dropout or L2 regularization, as well as data augmentation techniques such as synonym substitution or phrase reordering, to improve generalization and robustness. After training, the server uses the trained neural network to infer user attribute information from new behavior history vectors. This approach provides improved classification accuracy compared to manual rules or simple heuristic models, thereby improving the precision of personalization.

The server uses an information selection module to select target information based on user attribute information. The server retrieves item information such as product data or content data from an information storage device, which may be a product database or a content repository. Each item record contains fields such as item identifier, category, attributes, description, price, discount information, and stock status. The server uses the user's concern field and preference tendency scores to filter and rank items. For example, the server selects items whose category matches the user's primary concern field and whose attributes match finer-grained preferences such as “running,” “wireless,” or “budget.” The server may apply ranking algorithms that score items using a weighted combination of relevance to the user attribute information, recency, popularity, and availability. By performing this computation on the server using vectorized scoring and indexed lookups, the system reduces communication overhead with external services and avoids sending large irrelevant item sets to the generative AI model, thereby reducing overall processing time and network traffic.

The server uses a prompt construction module to generate a prompt sentence for a generative AI model. The server composes textual instructions that describe the user attribute information and the selected target information. In one example, the server constructs a prompt sentence such as:

“The user is highly interested in sports goods, especially running products such as running shoes and running watches. Using the following product information, generate an email body that introduces new running shoes and related accessories. Include any discounts or campaigns. Write a friendly and concise promotional message in English.”

In another example, the server constructs a prompt sentence such as:

“The user has recently searched for ‘wireless headphones’ and visited several electronics product pages. Based on the following product list, generate a personalized marketing email that highlights new wireless headphones and limited-time sale offers. Keep the tone informative and persuasive, and limit the email to about 3 short paragraphs.”

In yet another example, the server constructs a prompt sentence such as:

“The user recently searched for running shoes. Using the following product information, generate an email text that introduces new running shoes and current sale offers. Write in English, in a friendly but concise marketing style.”

The server may incorporate item names, prices, discount rates, and brief descriptions into the prompt sentence, or append them immediately after the main instruction. The server may control parameters such as desired length, tone, structure, presence of lists, and call-to-action phrases by embedding explicit directions in the prompt sentence. By algorithmically constructing the prompt sentence from structured user attribute and item information, the server ensures consistent conditioning of the generative AI model and reduces variability due to ambiguous instructions, resulting in more relevant and stable output.

The server uses a generative module to interact with a generative AI model. In one embodiment, the generative AI model is a neural network-based language model with a transformer architecture, comprising multiple layers of self-attention and feedforward sublayers. The model has been pre-trained on large-scale text corpora using an unsupervised language modeling objective, such as predicting the next token given previous tokens. The server communicates with the generative AI model via an application programming interface. The server sends the prompt sentence and any appended item descriptions as a tokenized input sequence to the generative AI model, along with control parameters such as maximum number of output tokens and temperature. The model computes, for each position, attention-weighted representations of the input tokens, applies nonlinear transformations, and iteratively generates tokens by sampling from the output probability distribution. The server receives the generated token sequence, decodes it into text, and obtains personalized information content.

The server may apply post-processing operations to the generated text, such as truncating text if it exceeds a predetermined length, removing repeated sentences, or checking whether essential item references are present by examining whether item identifiers, names, or key attributes appear in the text. If the generated content does not satisfy certain criteria, the server may adjust the prompt sentence or parameters and request regeneration. This feedback-based control improves the reliability of the generative AI model's output and aligns it more closely with the structured item data and user attributes.

The server uses a message assembly module to convert the personalized information content into an information message conforming to an electronic communication medium. For example, the server loads an email template comprising headers, formatting, and a footer, and inserts the personalized text into a body section. The server sets a subject line based on the concern field and key item information, such as “New Running Shoes and Exclusive Offers for You” or “Special Deals on Wireless Headphones You Recently Viewed.” The server assembles a structured message, including a recipient address corresponding to the user's email address, a sender address, and message body in both plain-text and markup language formats.

The server uses a communication module to transmit the information message over a communication network to the terminal. The server connects to an electronic mail transfer service or similar communication infrastructure using a specific protocol such as Simple Mail Transfer Protocol over a secure channel. The server sends the composed message and receives delivery status responses. The server may log status information including message identifiers and timestamps in a message log table. By using these structured logs, the server can monitor deliverability and optimize sending schedules, thereby improving throughput and reducing failed transmissions.

The terminal receives the information message from a mail server or messaging service. The terminal displays the subject and body text of the personalized content to the user. The user views the information and may select embedded links, which cause the terminal to send further requests to the server. The server can then record additional behavior history data and refine the user attribute information as described above.

This architecture improves computer technology in several respects. First, the server's integrated pipeline reduces redundant data transfer and repeated parsing by combining behavior logging, preprocessing, and user modeling in a unified data flow. By storing behavior history data in normalized, indexed structures and by performing text preprocessing and feature extraction in batch or near real time using optimized numerical libraries, the server reduces CPU cycles and memory accesses required to support personalization, thus increasing throughput. Second, the use of text feature quantities and statistical learning models enables more accurate inference of user concern fields and preference tendencies than simple count-based heuristics, reducing misclassification and improving the relevance of content. Third, the dynamic generation of prompt sentences from user attribute information and target item information provides precise conditioning of the generative AI model. This reduces the need for manually authored templates, lowers maintenance complexity, and improves the coverage of personalization cases without increasing rule-based logic. Fourth, by pre-filtering and ranking target information on the server and limiting the amount of data included in prompts, the system reduces the length of input sequences to the generative AI model and lowers computational load, resulting in faster response times and reduced cost per generated message.

The system also exhibits technical advantages in error reduction and robustness. By using normalized feature representations and trained statistical models, the server can handle noisy or inconsistent user inputs, such as misspellings or rare phrase combinations, with higher tolerance than manual rule systems. The use of learned embeddings and classification boundaries allows the server to generalize to new items and emerging user interests without redesigning rules, thus maintaining personalization performance over time. Moreover, the explicit feedback between the post-processing of generated content and the next prompt generation cycle enables adaptive control of the generative AI model, which further stabilizes the content quality and avoids pathological outputs such as empty messages or irrelevant topics.

Alternative embodiments are possible. In another embodiment, the server deploys the generative AI model on-premises rather than accessing it via an external interface. In such a case, the server may use specialized hardware such as a graphics processing unit for accelerating matrix operations in the transformer architecture. In this configuration, the server loads model weights into device memory and performs inference by repeatedly executing attention and feedforward layers on the hardware accelerator. This reduces inference latency and provides tighter control over resource allocation. In a different embodiment, the server may use a recurrent neural network or a convolutional neural network for text generation, although such models may be less efficient for long sequences. In yet another embodiment, the server uses a hybrid approach that employs a smaller, locally hosted language model for short notifications and an external larger model for long-form messages.

The server may vary the learning algorithms used for user attribute estimation. For example, in place of k-means clustering, the server may use density-based clustering, hierarchical clustering, or topic modeling such as latent Dirichlet allocation to derive concern fields as latent topics. For supervised learning, the server may use gradient boosting decision trees or support vector machines instead of a neural network. The server may also use an online learning algorithm that incrementally updates user attribute information as new behavior history data arrives, thereby improving timeliness and reducing the need for offline batch retraining.

The terminal and user roles may also vary. The terminal may be a dedicated application rather than a browser, in which case the terminal can capture additional behavioral signals such as gesture patterns or dwell time more precisely and send them in structured form to the server. The user may interact across multiple terminals, and the server may link behavior history data from different devices via an account identifier, thereby constructing a more complete behavior profile and improving the accuracy of the user attribute estimation.

In all these embodiments, the server uses concrete hardware resources and specific software modules to transform raw behavior signals into structured feature representations, to apply defined statistical models and neural network architectures with specified objective functions and optimization algorithms, to generate and control prompt sentences, and to deliver generated content via practical communication protocols. These operations extend beyond mere automation of human cognitive tasks and result in measurable improvements to the functioning of the computer system itself, including improved processing efficiency, improved data management, reduced communication load, and enhanced accuracy and stability of generated content.

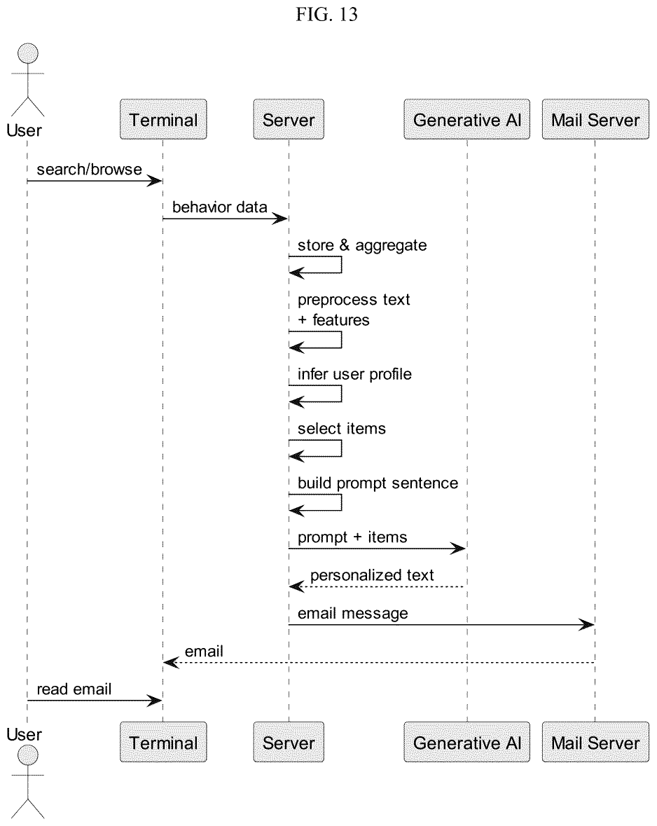

The following describes the processing flow using FIG. 13.

### Step 1:

The user operates the terminal to perform information search and browsing actions.
The user inputs search terms into a search field, selects links, scrolls through lists, and opens information presentation screens such as product detail pages.
The input to this step is a user's intent expressed as operations on the terminal's input devices (keyboard, touch panel, pointing device).
The output of this step is a sequence of user interaction events (for example, “search submitted”, “page viewed”, “link clicked”) that the terminal is able to detect and encode.

### Step 2:

The terminal generates behavior history data and transmits it to the server.
The terminal executes script code embedded in the displayed pages to capture user interaction events and packs these events into structured messages that include at least a user identifier, a timestamp, a search term, and screen identification information.
The input to this step is the sequence of interaction events generated in Step 1.
The terminal converts these events into data records by mapping each event to a record structure such as {user_id, event_type, term_text, screen_id, event_time}, and sends these records as request payloads over a communication network to the server.
The output of this step is behavior history data transmitted to the server as network messages.

### Step 3:

The server receives the behavior history data and stores it in a database.
The server parses each incoming network message, validates the fields, and converts the payload into a database row format.
The input to this step is the behavior history data transmitted from the terminal in Step 2.
The server performs data operations including type checking, normalization of timestamps, and mapping of screen identifiers to internal identifiers, and then executes insertion operations into a relational table such as a behavior_log table.
The output of this step is a persistent set of behavior history records stored in the server-side database.

### Step 4:

The server aggregates behavior history data per user and constructs raw text information.
The server queries the database to retrieve all relevant behavior_log entries associated with a particular user within a defined time window and concatenates textual fields such as search terms and titles of viewed screens.
The input to this step is a set of behavior history records stored in the database.
The server performs data aggregation by grouping records by user_id and ordering them by event_time, then concatenates term_text and screen titles into a combined text string for each user.
The output of this step is, for each user, one or more raw text sequences representing the user's recent behavior.

### Step 5:

The server performs text preprocessing on the raw text information to generate normalized token sequences.
The server applies a language processing algorithm that lowercases characters, removes punctuation, splits the text into lexical tokens, and removes stop words.
The input to this step is the raw text sequences constructed in Step 4.
The server performs text transformations by applying tokenization, normalization, stop-word removal, and optional stemming or lemmatization, thereby converting each text sequence into a cleaned token list such as [“running”, “shoe”, “lightweight”].
The output of this step is, for each user, a processed token sequence suitable for feature extraction.

### Step 6:

The server converts the processed token sequences into text feature quantities.
The server uses a feature extraction method such as a term frequency-inverse document frequency vectorizer to map tokens into numerical vectors.
The input to this step is the set of token sequences generated in Step 5.
The server builds a vocabulary index, computes term frequency and inverse document frequency statistics across users, and calculates weighted values for each term in each user's text; these values are organized into a matrix where rows correspond to users and columns correspond to terms.
The output of this step is, for each user, a text feature vector representing the user's behavior in a numeric feature space.

### Step 7:

The server estimates user attribute information from the text feature vectors using statistical learning.
The server applies a statistical learning model such as a clustering algorithm or a neural network classifier to classify or group users into concern fields and preference tendencies.
The input to this step is the set of text feature vectors generated in Step 6.
The server performs numerical operations such as distance calculations, gradient-based weight updates, or probability computations, depending on the chosen model. For clustering, the server assigns each user vector to a cluster and updates cluster centroids; for classification, the server feeds the vectors through a trained network to compute output probabilities for each concern field.
The output of this step is user attribute information for each user, including at least a concern field and a preference tendency score.

### Step 8:

The server stores and maintains the user attribute information in a dedicated data structure.
The server writes the user attribute information into a user attribute table, linking each user_id with fields representing primary concern field, secondary concern field, and numeric preference scores.
The input to this step is the user attribute information computed in Step 7.
The server executes database update operations such as insert or upsert, and may merge new scores with prior scores using weighted averaging or decay functions to reflect recent behavior more strongly.
The output of this step is an updated user attribute store that reflects the current inferred interests and tendencies of each user.

### Step 9:

The server selects target information relevant to the user attribute information.
The server queries an item or content database to retrieve items whose category or attributes match the user's concern field and preference tendency.
The input to this step is the user attribute information from Step 8 and item records stored in the item database.
The server performs join and filter operations to match items with concern fields, calculates relevance scores by combining attribute matches, recency, popularity, and availability, and ranks the items according to these scores.
The output of this step is, for each user, a ranked list of target items or content entries that are highly relevant to the user attribute information.

### Step 10:

The server constructs a prompt sentence based on the user attribute information and the target information.
The server assembles a natural language instruction that describes the user's interests and the selected items, and specifies the desired style and structure for the generated content.
The input to this step is the user attribute information from Step 8 and the ranked list of target items from Step 9.
The server performs string-formatting and template-filling operations, inserting category names, item descriptions, and instructions into a prompt template; the server may append item details as bullet-like lines following the main instruction. For example, the server generates prompt sentences such as:
“The user is highly interested in sports goods, especially running products such as running shoes and running watches. Using the following product information, generate an email body that introduces new running shoes and related accessories. Include any discounts or campaigns. Write a friendly and concise promotional message in English.”
or
“The user has recently searched for ‘wireless headphones’ and visited several electronics product pages. Based on the following product list, generate a personalized marketing email that highlights new wireless headphones and limited-time sale offers. Keep the tone informative and persuasive, and limit the email to about 3 short paragraphs.”
The output of this step is, for each user, a completed prompt sentence text ready to be supplied to a generative AI model.

### Step 11:

The server invokes the generative AI model with the prompt sentence and target information to generate personalized information content.
The server sends the prompt sentence and, optionally, appended item descriptions as input to a generative AI model via an application programming interface.
The input to this step is the prompt sentence text from Step 10 and the structured item data used as context.
The server converts the prompt text into tokens, sets generation parameters such as maximum token length and temperature, and transmits a generation request to the generative AI model. The model performs internal neural network computations to produce an output token sequence, and the server decodes this token sequence back into text.
The output of this step is personalized information content in text form, tailored to the user's concern field and the target items.

### Step 12:

The server post-processes the personalized information content and assembles an information message.
The server verifies that the generated text satisfies basic constraints such as minimum length and presence of at least one reference to a target item, and performs formatting or truncation if necessary.
The input to this step is the personalized information content text from Step 11 and the communication template information such as email header and footer.
The server inserts the personalized text into a message template, sets a subject line based on the concern field and key items (for example, “New Running Shoes and Exclusive Offers for You”), and constructs a complete message object with recipient address, sender address, and body in both plain-text and markup versions.
The output of this step is a structured information message that is ready for transmission via an electronic communication medium.

### Step 13:

The server transmits the information message to the terminal via a communication network.
The server connects to an electronic communication service using a standardized protocol and sends the composed message to the user's address.
The input to this step is the information message assembled in Step 12.
The server performs network operations such as establishing a secure session, formatting the message into protocol-compliant packets, and transmitting the packets to a mail transfer agent or messaging gateway, and then receives delivery status information.
The output of this step is the delivered information message stored in the user's mailbox or messaging inbox, accessible by the terminal.

### Step 14:

The terminal receives and displays the personalized information message to the user.
The terminal runs a client application that periodically checks for new messages, retrieves them from a message server, and renders their contents on the display unit.
The input to this step is the information message that has been delivered to the user's account in Step 13.
The terminal performs data retrieval from the message server, parses message headers and bodies, and renders text and links in a user interface; when the user opens the message, the terminal displays the personalized content and allows the user to activate links that lead back to the server.
The output of this step is the presentation of personalized information content on the terminal and, optionally, new interaction events that can be captured again as behavior history data.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information delivery systems that provide recommendations or advertisements to end users typically rely on static rule-based logic or simple collaborative filtering techniques operating on coarse behavior logs, such as aggregate purchase counts or generic category preferences. These systems suffer from multiple technical limitations in the way they process, represent, and utilize user behavior data within a computing environment.

First, known systems generally treat heterogeneous behavior logs (search history, browsing history, purchase history, and fine-grained action events) as separate, weakly correlated datasets, and therefore fail to construct unified and expressive feature representations for each user. As a result, the internal data structures used by the processor are not optimized to encode the nuanced temporal and contextual patterns of user behavior, which leads to suboptimal inference of user interests, preferences, and emotional states and reduces the effectiveness of subsequent automated content generation.
Second, existing architectures typically do not provide an integrated mechanism for generating, controlling, and updating natural language prompts for a generative AI model in a systematic way that is tightly coupled with machine-learned user models. In many cases, prompt content is crafted manually or in a fixed template format, disconnected from the underlying classification or clustering processes. This disconnect prevents the system from exploiting the full expressive power of generative AI, and limits the system's ability to adapt the wording, tone, and structure of generated text to specific user groups or delivery channels. As a result, the processor does not optimally use its computational resources for dynamic prompt construction and thus cannot efficiently generate highly relevant, context-aware content.
Third, conventional systems often lack a closed feedback loop in which user responses to generated content (such as clicks, dwell time on recommended content, or conversions) are reintegrated as structured behavior information and used to update both the feature representations and the prompt-generation logic. In such systems, behavior logs are either discarded after initial use or only aggregated in a coarse manner, preventing continuous refinement of user models and prompt strategies. This absence of a systematic feedback mechanism degrades the long-term performance of the recommendation pipeline and reduces the technical robustness and adaptability of the underlying computer system. In addition, many systems process emotion-related information, if at all, in a superficial way that does not integrate sentiment and affective signals into the feature space used by the processor for downstream tasks. Consequently, the system cannot consistently modulate the generated language tone or structure in response to inferred emotional states, and the internal computation flow of the processor remains largely insensitive to emotionally relevant behavioral patterns.

Accordingly, there is a need for an improved computer-implemented system that: (i) unifies heterogeneous user behavior logs into structured, machine-usable feature data; (ii) applies machine learning to classify users into preference and emotional-state groups in a manner that directly controls the construction of prompt sentences for a generative AI model; and (iii) closes a feedback loop by capturing user responses to generated content as additional behavior information and by automatically updating the estimation and prompt-construction processes. Such a system would improve the way the processor organizes, processes, and uses data within the computing environment, resulting in more efficient utilization of computational resources and more accurate, adaptive generation of personalized text and advertising information.

The specific processing by the specific processing unit 290 of the data processing device 12 in Application Example 2 is realized by the following means.

The present invention provides a server comprising a processor configured to acquire, from a user terminal, behavior information including search history, browsing history, purchase history, and action information related to the search history, the browsing history, and the purchase history of an end user, and to store the behavior information in a storage device as structured records; to preprocess the stored behavior information by normalizing and aggregating heterogeneous event data into unified feature data, to convert the behavior information into numerical feature vectors, and to estimate an interest, a preference, and an emotional state of the end user by applying statistical processing and machine learning processing to the numerical feature vectors, and to select target information related to the end user based on an estimation result; to construct a prompt sentence as a natural language instruction for a generative AI model based on the estimated interest, preference, and emotional state and the selected target information, the prompt sentence including dynamically selected elements such as an item group or an information group corresponding to the interest or the preference of the end user, an expression tone according to the emotional state of the end user, and a sentence length and structural components according to a delivery path, to input the prompt sentence into the generative AI model, and to cause the generative AI model to generate personalized text information or advertising information for the end user; to perform post-processing on the generated text information or advertising information, the post-processing including formatting for display, adding identification information and reference information of the target information, and converting the generated text information or the advertising information into an output format corresponding to a delivery medium; to deliver the converted text information or advertising information to the user terminal via a communication network in real time or as an electronic message, and to cause the user terminal to display the text information or the advertising information; and to acquire response behavior of the end user to the displayed text information or advertising information as additional behavior information, and to feed back the additional behavior information to the storage of the behavior information and to the estimation of the interest, the preference, and the emotional state of the end user, and to control contents and expression styles of subsequent prompt sentences based on updated classification of the end user into one or more preference groups or emotional-state groups. This enables the server to improve internal data handling and model control within the computing environment by unifying heterogeneous behavior data into optimized feature representations, by adaptively generating and refining prompt sentences for the generative AI model under direct control of machine-learned user classifications, and by closing a feedback loop in which user responses to generated content are reintegrated into the estimation and prompt-construction processes, thereby enhancing the technical performance, efficiency, and personalization capability of the computer-implemented information delivery system.

The term “behavior information” refers to electronic data representing actions performed by an end user, including but not limited to search history, browsing history, purchase history, and action events related to such history, which are collected from a user terminal and processed by the system.

The term “search history” refers to a set of records indicating queries or keywords input by an end user into a search interface, together with associated metadata such as timestamps, search context, and identifiers of resources retrieved in response to the queries.

The term “browsing history” refers to a set of records indicating content items, resources, or pages accessed or viewed by an end user, including associated metadata such as access timestamps, dwell time, and navigation paths.

The term “purchase history” refers to a set of records indicating goods, services, or digital items that have been ordered, purchased, or otherwise acquired by an end user, including associated metadata such as transaction time, quantity, price, and product category.

The term “action information” refers to event data describing discrete operations performed by an end user in relation to search, browsing, or purchasing, including but not limited to clicks, item selections, additions to a wishlist or cart, form submissions, and interaction with recommended content.

The term “user terminal” refers to an electronic device operated by an end user, such as a mobile device, a tablet device, a personal computer, or a similar computing device, which is configured to communicate with a server over a communication network and to present information to the end user.

The term “storage unit” refers to a logical or physical data storage resource, such as a database, a file system, or a memory subsystem, which is configured to store behavior information, feature data, and other data used or generated by the processor.

The term “preprocess” refers to performing one or more data transformation operations, such as cleaning, normalizing, aggregating, filtering, or structuring raw behavior information, in order to prepare the information for subsequent analysis and machine learning.

The term “feature data” refers to a structured representation of behavior information in which properties of user actions or items are encoded as attributes or variables that can be processed by statistical methods or machine learning algorithms.

The term “numerical feature vectors” refers to multi-dimensional numerical arrays that represent feature data in a form suitable for computation by a machine learning algorithm, where each element corresponds to a particular feature dimension.

The term “statistical processing” refers to computational procedures that analyze data using statistical methods, such as aggregation, distribution analysis, correlation analysis, or significance testing, to derive metrics or patterns from behavior information.

The term “machine learning processing” refers to computational procedures that apply algorithmic models, such as classification models, clustering models, or regression models, to feature data in order to infer properties, patterns, or predictions related to end users or items.

The term “interest” refers to a property associated with an end user that indicates a tendency or inclination toward particular topics, item categories, or types of content, as inferred from the user's behavior information.

The term “preference” refers to a property associated with an end user that indicates relative favorability or priority among item types, categories, or attributes, such as brand, price range, or style, as inferred from the user's behavior information.

The term “emotional state” refers to an affective condition attributed to an end user, such as joy, excitement, neutrality, or dissatisfaction, which is inferred from behavior information and associated features.

The term “target information” refers to content-relevant data selected for an end user based on estimated interest, preference, and emotional state, such as candidate items, item categories, or informational topics that may be included in generated text or advertising information.

The term “generative AI model” refers to an artificial intelligence model configured to generate content, such as natural-language text, in response to an input instruction or context, typically using probabilistic or neural network-based techniques.

The term “prompt sentence” refers to a natural-language instruction or query that is constructed by the processor and input to a generative AI model to control and specify the content, style, and structure of generated text information or advertising information.

The term “text information” refers to content primarily expressed in natural-language text, including but not limited to explanations, recommendations, messages, or notifications that are generated for presentation to an end user.

The term “advertising information” refers to text information that is specifically intended to promote goods, services, or offers to an end user, including descriptions, slogans, promotional messages, and calls to action.

The term “post-processing” refers to operations performed on generated text information or advertising information after it is produced by a generative AI model, including formatting, content adjustment, metadata insertion, and conversion to a delivery-compatible format.

The term “identification information” refers to data elements that uniquely or semi-uniquely identify items or content units associated with target information, such as item identifiers, category identifiers, or tracking codes.

The term “reference information” refers to data elements that indicate access or linkage details for target information, such as resource locators, deep links, or pointers that enable a user terminal to retrieve or present associated content.

The term “output format corresponding to a delivery medium” refers to a representation style or encoding of content that is adapted to requirements or constraints of a particular delivery channel, such as a structured data format for an application interface or a markup format for an electronic message.

The term “delivery medium” refers to a communication channel or mechanism through which content is transmitted from a server to a user terminal, including but not limited to application interfaces, web interfaces, and electronic messaging systems.

The term “communication network” refers to a wired or wireless data transmission infrastructure, such as the internet, a local area network, or a mobile communication network, used to exchange information between a server and a user terminal.

The term “electronic message” refers to digital communication content delivered to a user terminal through an electronic messaging system, such as an email system, a messaging application, or a notification service.

The term “response behavior” refers to actions taken by an end user in reaction to displayed text information or advertising information, including but not limited to clicks, scrolls, dwell time, link activations, purchases, or dismissals.

The term “preference group” refers to a category or cluster of end users that share similar inferred preferences, such as similar favored item categories, brands, or price ranges, as determined by machine learning processing.

The term “emotional-state group” refers to a category or cluster of end users that share similar inferred emotional states or emotional response patterns, as determined by machine learning processing.

The term “delivery path” refers to a route or context by which generated content is delivered to and presented on a user terminal, such as an in-application view, a web page, or an electronic message channel.

In one embodiment, a server implements the claimed system by executing computer programs on one or more processors and cooperating with one or more user terminals through a communication network. The server includes at least one central processing unit, a main memory, a non-volatile storage device, a network interface, and a database system. The server executes an operating system and application software including a web application framework, a data processing module, a machine learning module, and a generative AI interface module. The server stores behavior information, feature data, model parameters, and generated content in a structured storage unit, such as a relational database system or a NoSQL database system.

The server uses a software stack that may include a scripting language runtime, a web framework, and scientific computing libraries. For example, the server uses a Python runtime, a web framework such as a generic application framework, a data analysis library such as a tabular data library, and machine learning libraries such as a classical machine learning library, a neural network library, or a deep learning framework. The server further uses natural language processing libraries, such as tokenization and linguistic analysis toolkits, for text processing. The server uses an external generative AI model that is accessible through an application programming interface provided by a generative AI service.

The terminal is a computing device such as a smartphone, a tablet, or a personal computer. The terminal executes a client application, such as a native application developed with a cross-platform framework or a web browser rendering a web application. The terminal includes an input unit, a display unit, and a communication interface. The terminal collects user actions, such as typing queries, tapping buttons, scrolling, selecting items, and confirming purchases, and transmits corresponding behavior information to the server via the communication network.

The user operates the terminal by entering search queries, browsing lists of items, viewing detail pages, adding items to a cart or to a favorites list, and completing payment flows. The user also receives and views personalized text information and advertising information that the server generates and delivers to the terminal. When the user reacts to such content, for example by clicking a recommended item, the user indirectly causes additional behavior information to be generated and sent to the server.

The server represents behavior information in specific data structures. The server stores each user action as a log record including a user identifier, an event type, a timestamp, an item identifier or resource identifier, and optional attributes such as dwell time, device type, and referring context. The server may store search events in a search log table, browsing events in a page view log table, and purchase events in a transaction log table. Each table has indexed fields to support efficient retrieval by user identifier and by time interval. The server also maintains a user profile table that aggregates summary statistics and feature vectors for each user.

The server executes a behavior preprocessing module that transforms raw log records into unified feature data. The server uses a data analysis library to load log tables as in-memory data frames. The server normalizes textual fields, for example by converting text to lower case, removing stop words, and applying tokenization. The server maps categorical variables, such as item categories or device types, into numerical encodings. The server constructs temporal features such as recency and frequency of certain actions by computing aggregate counts over sliding time windows. The server concatenates these values into numerical feature vectors representing each user at a given time.

The server applies machine learning processing to the feature vectors to infer interests, preferences, and emotional states. In one embodiment, the server employs a classification and clustering pipeline. The server uses a clustering algorithm, such as a k-means algorithm implemented in a classical machine learning library, to partition users into preference groups based on vectors that encode item category frequencies, price-level statistics, and brand interaction patterns. The server uses a classification model, such as a neural network implemented in a deep learning framework, to predict an emotional state label from features including repeated search patterns, dwell times on specific content types, and sentiment scores of searched phrases and viewed texts.

The server implements the neural network for emotional state estimation as a multi-layer architecture with an input layer corresponding to the feature vector dimensions, one or more hidden layers with non-linear activation functions, and an output layer with units corresponding to possible emotional states, such as joy, excitement, neutrality, and dissatisfaction. The server trains this model offline using labeled training data. The server defines a loss function such as a cross-entropy function between predicted emotional state probabilities and ground-truth labels. The server updates model weights by gradient descent or a variant such as an adaptive gradient optimizer. During training, the server may apply data augmentation techniques, such as adding noise to dwell-time values or combining multiple sessions, to improve robustness. Once trained, the server stores the model parameters in the storage unit and loads them into memory for inference.

By using these specific data structures and learning algorithms, the server improves computational efficiency and accuracy. The server reduces the dimensionality of input signals through feature engineering, thereby decreasing memory usage and processing time for each inference. The server also uses batched inference to process multiple user profiles simultaneously, reducing overhead on the processor and on the memory subsystem. Because the server organizes behavior information into normalized feature vectors and clusters users into coherent groups, the server can reuse precomputed components of prompt sentences across similar users, thus reducing the number of calls to the generative AI model and lowering network traffic to the external model hosting service.

The server constructs prompt sentences according to a defined internal syntax. The server maintains prompt templates parameterized by elements such as interest categories, emotional states, delivery channels, and content length requirements. The server selects a template based on the user's preference group and emotional-state group, and fills slots in the template with user-specific information and candidate items. For example, the server may employ a template such as:

“Based on this user's past search history ([SEARCH_KEYWORDS]), browsing behavior, and [EMOTIONAL_STATE] emotional state, generate a short product recommendation message for an online shopping service. Mention new items in the category [CATEGORY_LIST] and any relevant sale information in a [TONE] tone.”

The server replaces [SEARCH_KEYWORDS] with a summary of the user's frequent queries, [EMOTIONAL_STATE] with an inferred label such as “excited,” [CATEGORY_LIST] with categories such as “running shoes, running socks, sportswear,” and [TONE] with descriptors such as “friendly and energetic.”

In another example, when the user shows interest in travel-related content, the server constructs a prompt sentence as:

“From the following user behavior: search history =[‘Hawaii trip’, ‘beach resort’, ‘surfing’], emotional state =excited, generate an English email body that recommends beach resorts in Hawaii and beginner surfing guides, including limited-time travel offers.”

In an additional example focusing on accessories, the server constructs a prompt sentence as:

“Using the user's recent search history about smartphone cases and smartphone accessories, and assuming a neutral emotional state, generate concise promotional text describing newly arrived smartphone cases and current discounts, suitable for a push notification.”

The server constructs these prompt sentences algorithmically rather than manually. The server maps internal feature representations and classification outputs to discrete textual tokens, chooses synonyms and phrasing patterns according to rules stored in a prompt generation module, and respects channel-specific constraints such as maximum length and required structure. Because the server dynamically composes prompt sentences from feature-level data and group-level models, the system changes generative AI input in ways that a human operator would not practically perform in real time across large user populations.

The server communicates with the generative AI model through a network-based interface. The server packs the constructed prompt sentence into a request data structure including model selection parameters, maximum token counts, and sampling temperature parameters. The server transmits this request via the network interface to a generative AI service. The generative AI service executes the generative AI model, which may be implemented as a transformer-based neural network with self-attention layers and positional encodings. The generative AI service returns generated text to the server, which the server parses and stores in the storage unit in association with the corresponding user identifier and context.

The server performs post-processing on the generated text to adapt it to the delivery medium. For in-application presentation, the server converts the text into a structured response containing title fields, body fields, and optional call-to-action fields. For electronic messages such as emails, the server wraps the generated text in a markup format, inserts hyperlinks to item detail pages using item identifiers from the target information, and appends tracking codes. The server also removes redundant phrases, enforces forbidden-word filters, and truncates or expands the text as necessary to meet display constraints.

The server delivers the processed text to the terminal or to an electronic messaging system. For in-application delivery, the server returns a structured response over a request-response protocol to the terminal. For email delivery, the server uses a mail transfer agent or an email delivery service to send messages to the user's email address. The server may schedule deliveries based on user activity patterns to reduce network congestion and to avoid unnecessary transmissions.

The terminal receives responses from the server and renders the text information or advertising information. In the case of a shopping application, the terminal creates a “recommended for you” section on a home screen or product list screen. The terminal displays textual descriptions, prices, discount information, and action buttons that link to detail views. When the terminal receives an electronic message such as an email, a mail client on the terminal presents the message body including the generated content.

The user then interacts with the displayed content. For example, the user clicks a recommended running shoe, scrolls through a list of suggested accessories, or follows a travel offer link. The user may also ignore or dismiss certain content. Each of these responses is recorded by the terminal as a new behavior event and sent back to the server.

The server incorporates this response behavior into the stored behavior information. The server tags these events with references to the specific generated content identifiers and prompt variants that led to the display. This design enables the server to measure performance metrics such as click-through rate, conversion rate, and dwell time for each prompt pattern and for each preference group. The server uses this feedback to retrain the classification and clustering models and to adjust prompt generation rules. For example, if a particular phrasing pattern yields lower engagement for a specific emotional-state group, the server reduces the probability of using that pattern for similar users. By implementing this closed-loop adjustment systemically and at scale, the server improves the precision and efficiency of the generative AI interaction beyond simple static templates.

This architecture improves computer technology in several concrete ways. The server reduces computational load by representing heterogeneous logs as compressed feature vectors and by grouping users for shared prompt patterns, thereby decreasing the number of distinct generative AI calls. The server improves accuracy of content relevance by integrating emotional-state classification into the feature pipeline, leading to more accurate mapping of users to prompt sentence styles. The server improves data management by organizing raw logs, features, and generated content in a coordinated schema with explicit linkages between user actions and generative outputs, which enables efficient retrieval and model retraining. The server further reduces communication load with the generative AI service by caching generated content for similar users and by controlling maximum token lengths dependent on delivery paths.

In an alternative embodiment, the server employs a different machine learning algorithm, such as a gradient-boosted tree ensemble, to classify user preferences instead of or in addition to clustering. The server may use an attention-based neural network to estimate emotional states directly from sequences of events, where the input is a sequence of encoded user actions and the network learns temporal dependencies. The server may also represent prompt sentences using a more rigid grammar-based template and generate parts of the prompt using symbolic rules while still delegating natural-language realization to the generative AI model. These variations still adhere to the core concept of integrating structured behavior-derived classifications with dynamic prompt construction and generative text production.

In another embodiment, the server executes all machine learning models on local hardware accelerators such as graphics processing units or tensor processing units. The server then only uses the external generative AI model for language generation, while performing feature extraction, clustering, and emotion classification entirely on-premises. This configuration further improves privacy and latency and reduces the amount of data transmitted over the communication network.

In yet another embodiment, the server supports multiple delivery paths, such as mobile application views, web notifications, and different categories of electronic messages. The server maintains separate prompt templates and content formatters for each path. By treating the delivery path as an explicit input to the prompt construction module and to the post-processing module, the server ensures that generated text is not only personalized to interests and emotional states but also optimized for the technical constraints and interaction patterns of each medium.

Across these embodiments, the server, the terminal, and the user cooperate through the described data structures, models, and algorithms. The server does not merely automate a human marketing workflow; rather, the server introduces non-conventional processing steps at the data representation and prompt construction levels, enabling the processor to manage and exploit behavior information in ways that would not be feasible by manual operation or by simple rule-based systems. This yields measurable improvements in processing speed, recommendation precision, communication efficiency, and adaptability of the computer-implemented information delivery system.

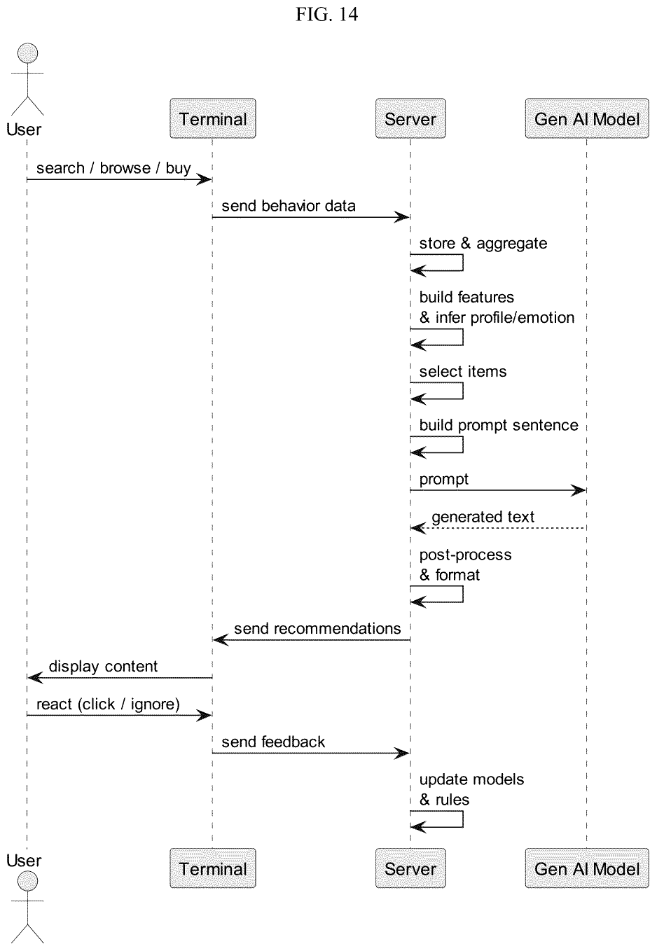

The following describes the processing flow using FIG. 14.

### Step 1:

The user operates the terminal to perform actions in an application or browser.

The user inputs search keywords, scrolls through lists, opens detail pages, adds items to a cart or favorites, and may complete purchases.

Input: User interactions such as keystrokes, taps, scroll events, and selection operations on the terminal UI.

Output: User interaction events captured inside the terminal, including search queries, item identifiers, timestamps, and UI context.

### Step 2:

The terminal generates behavior information records based on the user interactions.

The terminal assigns an event type (for example, “search,” “view,” “add_to_cart,” “purchase”), attaches a user identifier or session identifier, and measures additional attributes such as dwell time on pages.

The terminal formats these records as structured data (for example, key-value pairs or JSON objects).

Input: Raw user interaction events from Step 1.

Output: Structured behavior information records to be transmitted to the server.

### Step 3:

The terminal transmits the behavior information to the server through a communication network.

The terminal sends network requests to the server's application programming interface endpoints, including the structured event data in the request body, and waits for acknowledgments.

Input: Structured behavior information records from Step 2.

Output: Network requests containing behavior information, received by the server.

### Step 4:

The server receives the behavior information from the terminal and validates the data.

The server checks user identifiers, verifies required fields, filters malformed or suspicious records, and normalizes timestamps into a unified time zone.

Input: Network requests containing behavior information from Step 3.

Output: Cleaned and validated behavior information records suitable for storage.

### Step 5:

The server stores the validated behavior information in a storage unit.

The server writes search events into a search history table, page views into a browsing history table, and purchase events into a transaction table, each with indexed fields for user identifier and time.

Input: Cleaned and validated behavior information records from Step 4.

Output: Persisted behavior logs organized into database tables or collections.

### Step 6:

The server aggregates behavior information for each user.

The server retrieves recent records for a target user, groups events by type and category, calculates frequencies, recency values, and summary statistics, and builds a unified behavior profile.

Input: Behavior log records from search, browsing, and purchase tables in Step 5.

Output: Aggregated user behavior profiles containing counts, recency measures, and category-level summaries.

### Step 7:

The server transforms the aggregated behavior profiles into numerical feature vectors.

The server tokenizes search queries, converts tokens into numerical indices or embeddings, encodes item categories and device types as one-hot or multi-hot vectors, and concatenates these representations with numerical statistics such as dwell-time averages and purchase frequencies.

Input: Aggregated behavior profiles from Step 6.

Output: Numerical feature vectors representing each user's behavior in a fixed-dimensional space.

### Step 8:

The server estimates the user's interests and preferences using machine learning processing.

The server applies algorithms such as clustering or classification on the feature vectors to assign each user to one or more preference groups (for example, “sports,” “travel,” “electronics”) and to infer favored price ranges or brands.

Input: Numerical feature vectors from Step 7.

Output: Interest and preference estimation results, including group assignments and preference scores for item categories and attributes.

### Step 9:

The server estimates the user's emotional state using a trained model.

The server feeds the feature vectors and derived sentiment features (for example, sentiment scores of recent queries and texts) into a neural network or similar classifier, obtains probability scores for emotional states such as joy, excitement, neutrality, or dissatisfaction, and selects the most probable state.

Input: Numerical feature vectors and sentiment-related features derived from the behavior information.

Output: An emotional state label and associated confidence scores for the user.

### Step 10:

The server selects candidate target information for the user based on interests and preferences.

The server queries an item catalog or information repository using preferred categories, brands, and price ranges, filters out unavailable or already-shown items, and ranks candidates using a scoring function that combines preference scores and recent behavior signals.

Input: Interest and preference estimation results from Step 8 and catalog or content repository data.

Output: A ranked list of candidate target items or information entries to be recommended.

### Step 11:

The server constructs a prompt sentence for a generative AI model based on the user's profile.

The server chooses a prompt template according to the user's preference group, emotional state, and delivery path (for example, in-app message, email, or notification), and fills template slots with user-specific data, such as frequent search keywords, candidate categories, and tone indicators.

For example, the server constructs a prompt sentence such as: “Based on this user's past search history (running shoes, running socks, sportswear), browsing behavior, and an excited emotional state, generate a short product recommendation message for an online shopping service. Mention new running shoes, matching socks, and any relevant sale information in a friendly and energetic tone.”

Input: Interest and preference results from Step 8, emotional state from Step 9, and candidate target information from Step 10.

Output: A fully composed prompt sentence in natural language, ready to be sent to the generative AI model.

### Step 12:

The server sends the prompt sentence to the generative AI model and receives generated text.

The server creates a request including the prompt sentence and model configuration parameters (such as maximum output length and sampling settings), transmits the request to the generative AI service, and waits for the response.

The generative AI model processes the prompt sentence and returns generated text, such as recommendation messages or email bodies.

Input: Prompt sentence from Step 11 and configuration parameters for the generative AI model.

Output: Generated text information or advertising information output by the generative AI model.

### Step 13:

The server performs post-processing on the generated text.

The server removes inappropriate phrases using filter rules, inserts concrete item names, prices, and links drawn from the candidate target information list, and formats the text according to the chosen delivery path (for example, splitting into title and body fields for in-app display, or wrapping in a message body for email).

Input: Generated text information from Step 12 and candidate target information from Step 10.

Output: Finalized text information or advertising information, structured and formatted for delivery.

### Step 14:

The server delivers the finalized content to the terminal or to an electronic messaging system.

For real-time in-app recommendations, the server sends a structured response via a network interface directly to the terminal. For emails or notifications, the server forwards the content to an email delivery system or a notification service.

Input: Finalized and formatted text content from Step 13, along with destination identifiers such as user IDs or email addresses.

Output: Transmitted content payloads delivered across the communication network toward the terminal or messaging system.

### Step 15:

The terminal receives the delivered content and displays it to the user.

The terminal parses the server's response or the incoming message, creates visual components such as recommendation cards or message views, and renders item descriptions, prices, and call-to-action buttons on the display.

Input: Delivered content payloads from Step 14.

Output: Visual presentation of personalized text information or advertising information on the terminal's user interface.

### Step 16:

The user reacts to the displayed content.

The user may click recommended items, scroll through suggestions, follow embedded links, or ignore certain sections. These reactions reflect the user's interest level and satisfaction with the generated content.

Input: Displayed content and on-screen controls from Step 15.

Output: New user interactions that express response behavior to the generated content.

### Step 17:

The terminal captures the user's response behavior and reports it to the server.

The terminal records events such as “recommendation_click,” “email_open,” or “link_follow,” tags them with identifiers of the presented content and the underlying prompt variation, and sends these records to the server in the same structured format used for other behavior information.

Input: User response interactions from Step 16.

Output: Structured response behavior records transmitted to the server.

### Step 18:

The server integrates the response behavior into the behavior information database.

The server stores these new events, links them to the original generated content and prompt version, and updates aggregate statistics such as click-through rates and conversion rates per prompt pattern and per user group.

Input: Response behavior records from Step 17 and existing behavior logs from earlier steps.

Output: Updated behavior information and performance metrics associated with users, items, and prompt sentence variants.

### Step 19:

The server updates models and prompt generation rules based on the accumulated feedback.

The server retrains or fine-tunes clustering and classification models using the expanded dataset, recalculates group boundaries or decision thresholds, and adjusts prompt templates or slot-filling rules to emphasize patterns that yield higher engagement.

Input: Updated behavior information and performance metrics from Step 18.

Output: Refined model parameters and revised prompt generation rules that will influence future prompt sentences and generated content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

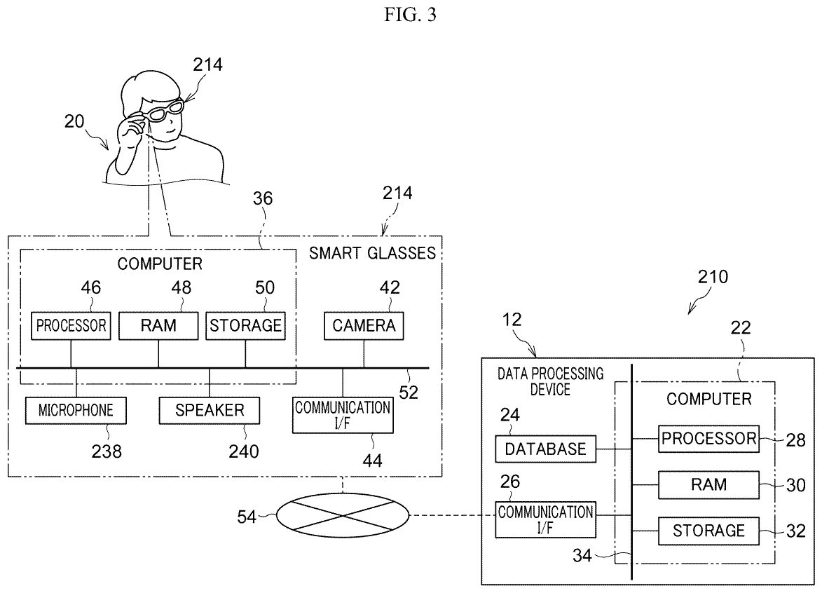

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

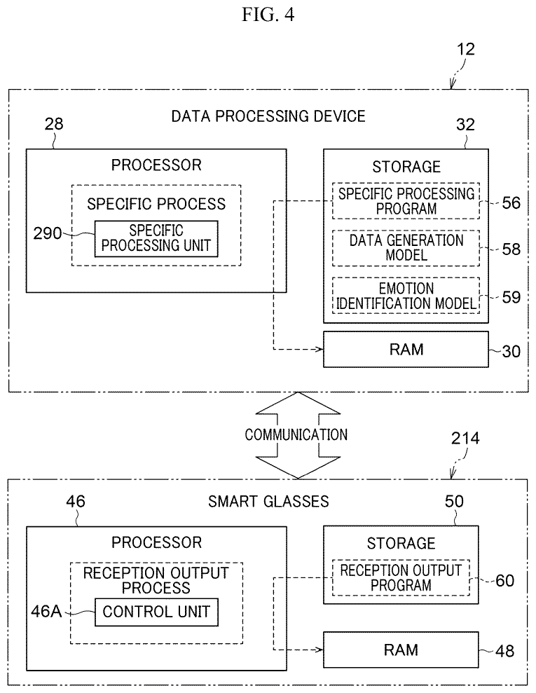

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

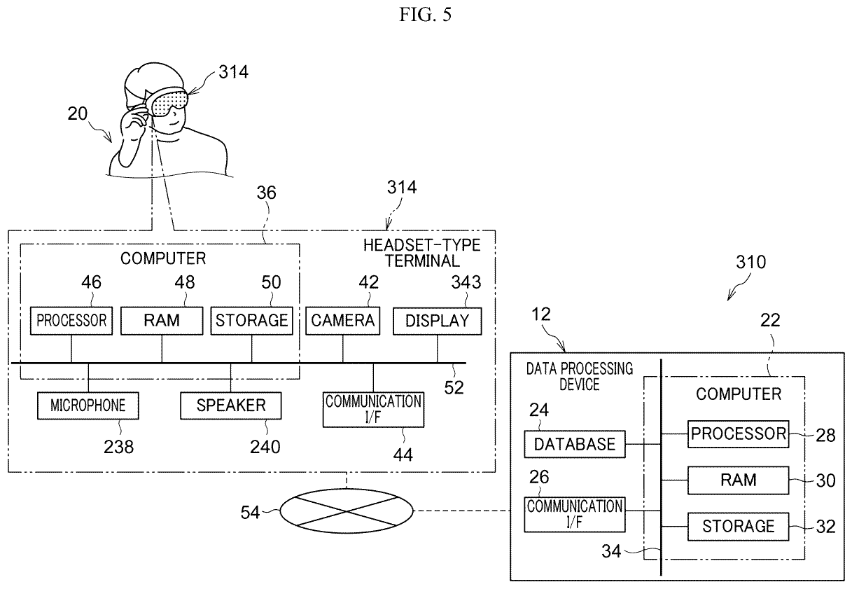

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

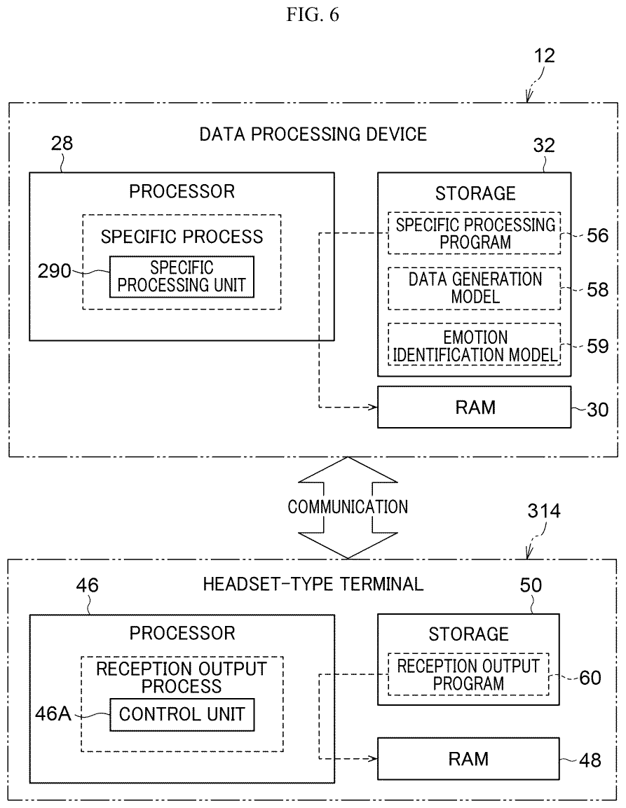

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

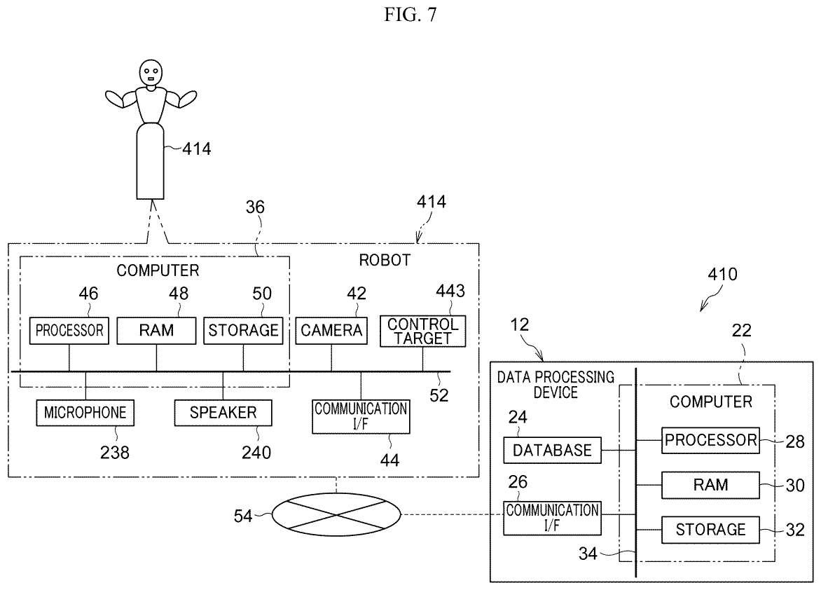

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

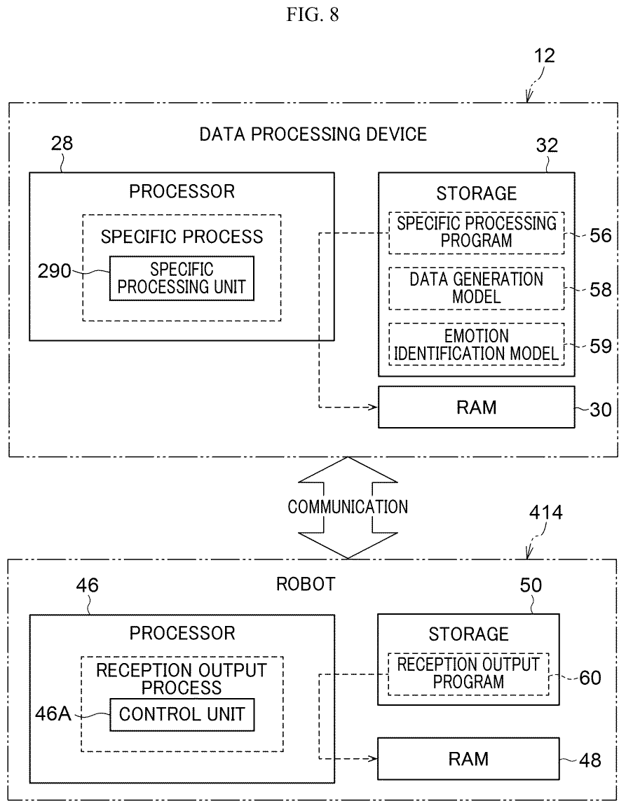

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

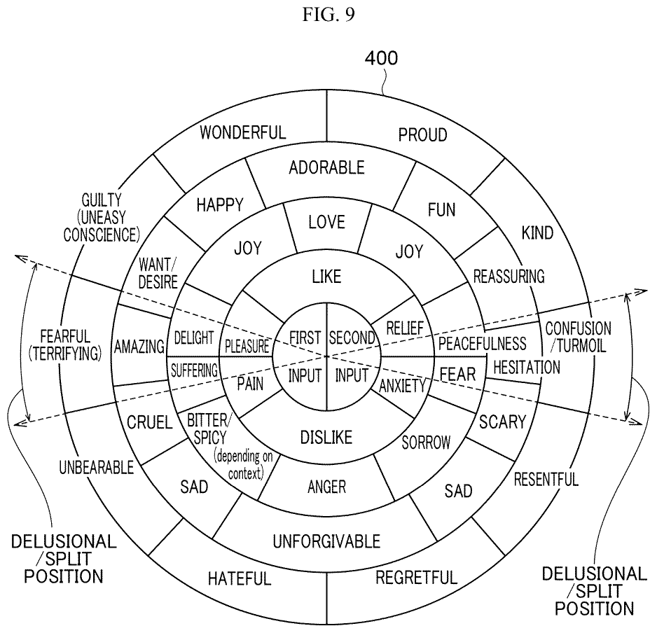

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

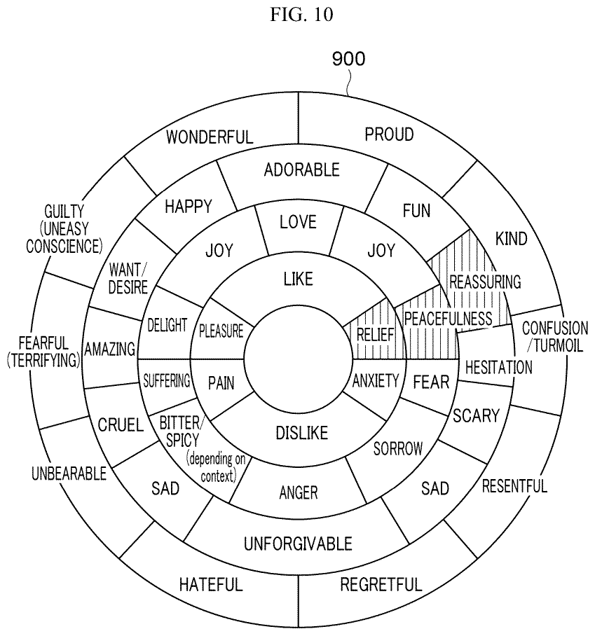

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to
collect operation history information of an end user from a terminal via a communication network, store, as a data set, history information including search character strings, identification information of presentation resources, and time information as the operation history information, and associate the data set with identification information of the end user,
perform preprocessing on the data set by executing, by use of a data processing program operating on a general-purpose information processing apparatus, data structure conversion, duplicate elimination, and character string normalization, apply a feature generation algorithm and a machine learning algorithm to the preprocessed data set, estimate, for each end user, interest category information and preference category information, and store the interest category information and the preference category information as interest information in association with the identification information of the end user,
select, based on the interest information, one or more main interest categories for each end user, construct a prompt sentence including at least the one or more main interest categories, document format conditions, expression style conditions, and information amount conditions, and create generation request data including the prompt sentence as input information for a generative information generation model,
execute the generative information generation model on an external information processing service or on an internal information processing resource by using the generation request data, generate, according to the prompt sentence, personalized text information or advertisement information for each end user, and acquire the personalized text information or the advertisement information as a generation result, perform postprocessing on the acquired personalized text information or advertisement information by adding a greeting sentence, a closing sentence, and compliance information, thereby constructing personalized distribution content, and transmit the personalized distribution content to the end user via an electrical communication path in accordance with an electronic communication protocol so that a display device of the terminal presents the personalized distribution content.

### (Supplementary 2)

The system according to supplementary 1,

wherein the processor is configured to
use, as the machine learning algorithm, a learning model that performs feature extraction processing for converting character string information into numerical feature quantities and performs classification processing or clustering processing, and calculate the interest category information and the preference category information based on an estimation result obtained by the learning model.

### (Supplementary 3)

The system according to supplementary 1,

wherein the processor is configured to include, in construction of the prompt sentence, topic content corresponding to the one or more main interest categories, attribute information of the end user, type information of a distribution medium, and a desired character count range, thereby causing the generative information generation model to generate, for each end user, content having a personalized text structure and a personalized information detail level.

### Application Example 1

### (Supplementary 1)

A system comprising a processor,

wherein the processor is configured to
acquire, via an input/output apparatus connected to an information processing apparatus and through an electronic communication path, user behavioral history information including search history information and purchase history information from a user terminal, and store the behavioral history information as structured information in a storage device, and
aggregate the stored behavioral history information by using a general-purpose information processing program and a data processing program, and generate topic information representing matters of interest related to the user by performing extraction of phrases, normalization of word forms, and calculation of occurrence frequencies with a natural language processing program, and estimate an interest, a preference, and an emotional state of the user based on the topic information, and
automatically generate a prompt sentence, which is an instruction sentence to be input to a generative information processing model, in accordance with the estimated interest, preference, emotional state, and the topic information, and cause the generative information processing model to generate personalized text information and advertising information for the user by inputting the prompt sentence to the generative information processing model, and
construct, by using a telecommunication service program, an electronic message including the text information and the advertising information generated by the generative information processing model as an electronic mail, and transmit the electronic mail to the user terminal via an electronic communication unit.

### (Supplementary 2)

The system according to supplementary 1,

wherein the processor is configured to classify or perform regression estimation of the interest, the preference, and the emotional state of the user by a machine learning algorithm based on a result of the extraction and normalization of phrases by the natural language processing program and statistical information of the behavioral history information, and dynamically change a wording structure and content elements of the prompt sentence in accordance with an estimation result.

### (Supplementary 3)

The system according to supplementary 1,

wherein the processor is configured to select at least one text template information item from among a plurality of text template information items associated with the topic information and the interest, the preference, and the emotional state of the user in the automatic generation of the prompt sentence, and insert the topic information and sales promotion condition information into variable portions of the selected text template information item, thereby configuring the text information and the advertising information output from the generative information processing model to include personalized content for each user.

### Example 2

### (Supplementary 1)

A system comprising a processor,

wherein the processor is configured to
acquire, from a communication terminal, behavior history data regarding an end user's information search actions and information browsing actions, and store, as the behavior history data, at least search terms and identification information of information presentation screens, and
preprocess the behavior history data as text information, convert the text information into feature quantities, estimate user attribute information indicating a concern field and a preference tendency of the end user by performing statistical learning processing based on the feature quantities, and store the user attribute information in a storage device, and extract, from an information storage device, target information having high relevance to the user attribute information, and dynamically generate a prompt sentence to be input to a generative information processing model on the basis of the user attribute information and the target information, and
input the prompt sentence and the target information into the generative information processing model, and cause the generative information processing model to generate personalized information content for the end user, and configure the personalized information content as an information message to be transmitted to the end user via an electronic communication medium, and distribute the information message to the communication terminal of the end user through a communication network.

### (Supplementary 2)

The system according to supplementary 1,

wherein the processor is configured to
in the preprocessing of the behavior history data, generate text feature quantities by performing, by a language processing algorithm, segmentation, normalization, and removal of unnecessary terms on the search terms and the identification information, and perform clustering or classification of the user attribute information by a statistical learning model on the basis of the text feature quantities.

### (Supplementary 3)

The system according to supplementary 1,

wherein the processor is configured to
when generating the prompt sentence, include category information indicating the user attribute information and item information indicating the target information relating to a product or a service, thereby controlling the generative information processing model to generate the personalized information content in which content and expression style differ for each end user.

### Application Example 2

### (Supplementary 1)

A system comprising a processor,

wherein the processor is configured to acquire, from a user terminal, behavior information including search history, browsing history, purchase history, and action information related to the search history, the browsing history, and the purchase history of an end user, and store the behavior information in a storage unit,
preprocess the stored behavior information, convert the behavior information into feature data, and estimate an interest, a preference, and an emotional state of the end user by using statistical processing and machine learning processing, and select target information related to the end user based on a result of the estimation,
construct a prompt sentence as a natural language instruction for a generative AI model based on the estimated interest, preference, and emotional state and the selected target information, input the prompt sentence into the generative AI model, and cause the generative AI model to generate personalized text information or advertising information for each end user,
perform post-processing on the generated text information or advertising information, the post-processing including formatting for display, adding identification information and reference information of the target information, and converting the generated text information or the advertising information into an output format corresponding to a delivery medium,
deliver the converted text information or advertising information to the user terminal via a communication network in real time or as an electronic message, and cause the user terminal to display the text information or the advertising information, and
acquire response behavior of the end user to the displayed text information or advertising information as additional behavior information, and feed back the additional behavior information to the storage of the behavior information and to the estimation of the interest, the preference, and the emotional state of the end user.

### (Supplementary 2)

The system according to supplementary 1,

wherein the processor is configured to convert the behavior information into numerical feature data, classify the end user into one or more preference groups or emotional-state groups by performing classification processing or clustering processing as the machine learning processing, and control contents and expression styles of the prompt sentence based on a result of the classification.

### (Supplementary 3)

The system according to supplementary 1,

wherein the processor is configured, in constructing the prompt sentence, to dynamically select and combine elements of the prompt sentence such that the prompt sentence includes an item group or an information group corresponding to the interest or the preference of the end user, an expression tone according to the emotional state of the end user, and a sentence length and structural components according to a delivery path, thereby causing the generated text information or advertising information to be personalized for each end user.

What is claimed is:

1. A system comprising:
circuitry configured to:
collect interaction log records associated with an entity from a terminal apparatus via a packet-switched network;
preprocess the interaction log records by executing data structure conversion, duplicate elimination, and character string normalization on the interaction log records;
apply a feature generation algorithm to the preprocessed interaction log records to produce numerical feature vectors, and apply a machine learning algorithm to the numerical feature vectors to estimate category classification data for the entity;
construct a parameterized instruction sequence including at least the category classification data, document format condition data, expression style condition data, and information quantity condition data; and
provide the parameterized instruction sequence to a generative neural network model to cause the generative neural network model to generate structured output data corresponding to the category classification data.

2. The system according to claim 1, wherein the circuitry is further configured to:
apply, as the feature generation algorithm, a term-frequency-inverse-document-frequency vectorization to character string data within the preprocessed interaction log records to produce the numerical feature vectors.

3. The system according to claim 2, wherein the circuitry is further configured to:
apply, as the machine learning algorithm, a classification model having an input layer corresponding to dimensions of the numerical feature vectors, one or more hidden layers with non-linear activation functions, and an output layer that computes probability distributions over a predetermined set of category labels, and determine the category classification data based on output probabilities of the classification model.

4. The system according to claim 3, wherein the circuitry is further configured to:
select, based on the category classification data, one or more dominant category labels for the entity by identifying category labels having probability values exceeding a threshold or belonging to a top-rank subset, and incorporate the one or more dominant category labels into the parameterized instruction sequence.

5. The system according to claim 4, wherein the circuitry is further configured to:
estimate affective state classification data for the entity based on the numerical feature vectors by applying a sentiment analysis model to character string data within the interaction log records, and incorporate the affective state classification data into the parameterized instruction sequence to control a tone characteristic of the structured output data.

6. The system according to claim 5, wherein the parameterized instruction sequence further includes topic content data corresponding to the one or more dominant category labels, attribute parameter data of the entity, distribution medium type information, and a character count range specification, such that the generative neural network model generates the structured output data having a text structure and an information detail level corresponding to the entity.

7. The system according to claim 6, wherein the interaction log records include query character string records representing retrieval operations performed by the entity and transaction event records representing acquisition operations performed by the entity, and wherein the circuitry stores the query character string records and the transaction event records as structured records in a storage medium in association with identification information of the entity.

8. The system according to claim 7, wherein the circuitry is further configured to:
aggregate the stored query character string records and transaction event records by executing a natural language processing program to perform extraction of phrases, normalization of word forms, and calculation of occurrence frequencies, thereby generating topic data representing fields of relevance to the entity.

9. The system according to claim 8, wherein the circuitry is further configured to:
select at least one template data structure from among a plurality of template data structures based on the topic data and the category classification data, and insert the topic data and constraint condition data into variable portions of the selected template data structure to construct the parameterized instruction sequence.

10. The system according to claim 5, wherein the circuitry is further configured to:
perform postprocessing on the structured output data by adding an introductory segment, a concluding segment, and compliance data to construct distribution content data, and transmit the distribution content data to the terminal apparatus via the packet-switched network in accordance with an electronic communication protocol.

11. The system according to claim 10, wherein the circuitry transmits the distribution content data as electronic message data including a destination address field derived from the identification information of the entity and a body field containing the structured output data, via a message transfer protocol over the packet-switched network.

12. The system according to claim 10, wherein the generative neural network model comprises a transformer-based architecture including a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

13. The system according to claim 12, wherein the circuitry is further configured to:
receive, from the terminal apparatus, response behavior data comprising selection event records, duration metric data, and evaluation signal records associated with previously transmitted distribution content data, and update the category classification data based on the response behavior data by applying a weighted moving average to per-category relevance scores derived from the response behavior data.

14. The system according to claim 13, wherein the circuitry is further configured to:
re-execute the feature generation algorithm and the machine learning algorithm using updated interaction log records that include the response behavior data, reconstruct the parameterized instruction sequence using updated category classification data, and cause the generative neural network model to generate updated structured output data.

15. The system according to claim 10, wherein the circuitry is further configured to:
convert the interaction log records into text feature quantities using a language processing algorithm that performs segmentation, normalization, and stop-word removal, estimate attribute parameter data indicating a concern field and a preference tendency of the entity by performing statistical learning processing based on the text feature quantities, and store the attribute parameter data in the storage medium.

16. The system according to claim 15, wherein the circuitry is further configured to:
extract, from an information storage device, target data records having high relevance to the attribute parameter data, and incorporate the target data records into the parameterized instruction sequence such that the generative neural network model generates the structured output data with content and expression style adapted to the entity.

17. The system according to claim 16, wherein the circuitry is further configured to:
classify the entity into one or more preference group labels or affective state group labels by performing clustering processing or classification processing on the numerical feature vectors, and control content elements and expression style elements of the parameterized instruction sequence based on the preference group labels or the affective state group labels.

18. A system comprising:
circuitry configured to:
collect, via a communication interface coupled to a packet-switched network, interaction log records from a terminal apparatus, the interaction log records including query character string records and resource identification records associated with an entity;
preprocess the interaction log records by executing data structure conversion, duplicate elimination, and character string normalization;
apply a feature generation algorithm to produce numerical feature vectors from the preprocessed interaction log records, and apply a machine learning algorithm comprising a classification model with a plurality of hidden layers to the numerical feature vectors to estimate category classification data and affective state classification data for the entity;
construct a parameterized instruction sequence incorporating at least the category classification data, the affective state classification data, document format condition data, expression style condition data, and information quantity condition data;
provide the parameterized instruction sequence to a generative neural network model having a transformer-based architecture including a plurality of self-attention layers to cause the generative neural network model to generate structured output data corresponding to the category classification data and the affective state classification data; and
transmit the structured output data to the terminal apparatus via the packet-switched network.

19. The system according to claim 18, wherein the circuitry is further configured to:
receive response behavior data from the terminal apparatus comprising selection event records and evaluation signal records, update the category classification data and the affective state classification data based on the response behavior data, and reconstruct the parameterized instruction sequence using the updated category classification data and affective state classification data to cause the generative neural network model to generate updated structured output data.

20. A method performed by circuitry, the method comprising:
collecting interaction log records associated with an entity from a terminal apparatus via a packet-switched network;
preprocessing the interaction log records by executing data structure conversion, duplicate elimination, and character string normalization on the interaction log records;
applying a feature generation algorithm to the preprocessed interaction log records to produce numerical feature vectors, and applying a machine learning algorithm to the numerical feature vectors to estimate category classification data for the entity;
constructing a parameterized instruction sequence including at least the category classification data, document format condition data, expression style condition data, and information quantity condition data; and
providing the parameterized instruction sequence to a generative neural network model to cause the generative neural network model to generate structured output data corresponding to the category classification data.
